(19) United States
(12) Patent Application Publication
(10) Pub. No.: US 2007/0100475 A1
(43) Pub. Date: May 3, 2007

(54) Method and apparatus for applying reduced nonlinear models to optimization of an operation

(76) Inventor: William Joseph Korchinski, Santa Barbara, CA (US)

Correspondence Address: William Joseph Korchinski, 1516 Sinaloa Drive, Santa Barbara, CA, 93108, US

(21) Appl. No.: 11/257,478

(22) Filed: Oct. 25, 2005

(51) Int. Cl. G05B 13/02

(52) U.S. Cl. 700/28; 700/29; 700/30; 700/31

(57) ABSTRACT

A method and apparatus are disclosed for generating a reduced nonlinear model, whose significant properties include accuracy, compact size, reliability and speed. These properties enable nonlinear real-time optimization and detailed analysis of any operation that can be modeled this way. An array of related applications is disclosed for providing a deep understanding of the behavior of the optimum of an operation. Such understanding includes the ability to directly visualize an objective function response surface and the detailed interrelationships between independent and dependent variables for optimal operation. Additional applications are disclosed for verbally expressing operating instructions based on optimality of an operation, and an accurate means to quantify the ongoing benefits due to nonlinear optimization.

### FIELD OF THE INVENTION

The present invention relates generally to a system for solving optimization problems. More particular still, the invention relates to a computerized system for solving and analyzing nonlinear optimization problems in real time using a particular approach based on a reduced model of the operation being optimized.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO COMPUTER PROGRAM LISTING APPENDICES

The accompanying appendix is comprised of the respectively listed files, all of which are included on the compact disc filed with this application, and incorporated herein by reference:

LENGTHY TABLES FILED ON CD
The patent application contains a lengthy table section. A copy of the table is available in electronic form from the USPTO web site (http://seqdata.uspto.gov/?pageRequest=docDetail&DocID=US20070100475A1). An electronic copy of the table will also be available from the USPTO upon request and payment of the fee set forth in 37 CFR 1.19(b)(3).

APPENDIX A—exemplary application, listed here as files designated with extension “vb”, is implemented in Visual Basic, by Microsoft Corporation, using calls to NLP, Copyright 1997, a Quasi-Newton minimization routing by C. David Eagle, Jr. of Littleton, Colo. The exemplary application also uses graphical display components provided by Syncfusion, Essential Suite version 3.0.1.0, Morrisville NC and Dundas Chart Software version 4.5.0.1683, Toronto, Ontario, Canada. The exemplary application also comprises a relational database, each table of which is represented here by a files the extension “txt”.

| | | | |
|---|---|---|---|
| Form1.vb | Aug. 31, 2005 | 75,121 | bytes |
| frmMain.vb | Aug. 31, 2005 | 1,264,655 | bytes |
| frmTuning.vb | Aug. 31, 2005 | 54,769 | bytes |
| modLoadModel.vb | Aug. 31, 2005 | 16,424 | bytes |
| modMain.vb | Aug. 31, 2005 | 32,468 | bytes |
| modUsrFun.vb | Aug. 31, 2005 | 48,324 | bytes |
| modUsrReports.vb | Aug. 31, 2005 | 30,256 | bytes |
| CVs.txt | Sep. 15, 2005 | 7,179 | bytes |
| IndependentsNonlinear.txt | Sep. 15, 2005 | 495 | bytes |
| LinearModel.txt | Sep. 15, 2005 | 2,160 | bytes |
| LPVariableTypes.txt | Sep. 15, 2005 | 188 | bytes |
| LPVector_New.txt | Sep. 15, 2005 | 2,112 | bytes |
| LPVectorFromPlant.txt | Sep. 15, 2005 | 2,112 | bytes |
| ModelCoefficientsBase.txt | Sep. 15, 2005 | 2,703 | bytes |
| ModelCoefficientsUpdated.txt | Sep. 15, 2005 | 2,703 | bytes |
| MVs.txt | Sep. 15, 2005 | 1,727 | bytes |
| PlantDataArchive.txt | Sep. 15, 2005 | 47,550 | bytes |
| PlantSolution.txt | Sep. 15, 2005 | 4,618,340 | bytes |
| PlotsEngineer.txt | Sep. 15, 2005 | 22,190 | bytes |
| PlotsOperator.txt | Sep. 15, 2005 | 19,188 | bytes |
| QuickOptimizerContext.txt | Sep. 15, 2005 | 740 | bytes |
| Reports.txt | Sep. 15, 2005 | 157,726 | bytes |

APPENDIX B—exemplary application, showing steps to build a reduced model, is documented in Appendix B. Each of the files in Appendix B represents a single table illustrating one step in producing a reduced model. The first line of each file shows the table number, along with a brief description of what is contained in that table. For example the first line of TABLE 1.txt defines that table as “First-principles model variable names and values”. Because the tables of Appendix B are exemplary in nature, they have generally been abbreviated, leaving only representative parts for illustration.

The accompanying appendix is comprised of the respectively listed tables, all of which are included on the compact disc filed with this application, and incorporated herein by reference:

| | | | |
|---|---|---|---|
| TABLE B1.TXT | Oct. 11, 2005 | 17,565 | bytes |
| TABLE B2.TXT | Oct. 11, 2005 | 12,586 | bytes |
| TABLE B3.TXT | Oct. 11, 2005 | 8,083 | bytes |
| TABLE B4.TXT | Oct. 11, 2005 | 8,045 | bytes |
| TABLE B5.TXT | Oct. 11, 2005 | 2,338 | bytes |
| TABLE B6.TXT | Oct. 11, 2005 | 2,112 | bytes |
| TABLE B7.TXT | Oct. 11, 2005 | 1,163 | bytes |
| TABLE B8.TXT | Oct. 11, 2005 | 735 | bytes |
| TABLE B9.TXT | Oct. 11, 2005 | 620 | bytes |
| TABLE B10.TXT | Oct. 11, 2005 | 620 | bytes |
| TABLE B11.TXT | Oct. 11, 2005 | 784 | bytes |

### BACKGROUND OF THE INVENTION

The invention is generally deployed in the context of an “operation”, an operation consisting of: a continuous process (such as all or part of an oil refinery, oil and gas production facility, chemical plant pulp mill, steel mill); a utility (steam or hydrogen generation); traffic flow analysis (vehicular, airline); telecommunications; military operations (troop movement, aircraft scheduling); environmental emissions control (automobile, industrial); or any other similar undertaking, having multiple ways of achieving an objective, some more efficient than others.

One example of an “operation” is a simulation of the earth's climate, such as might be used to calculate the impact of the Kyoto treaty (signed in Kyoto, Japan, December 1997) on global carbon dioxide emissions. A recent such simulation is described in MIT Global System Model (IGSM) version 2, Andrei P. Sokolov et al., Report 124, July 2005. The Sokolov model contains input variables such as solar energy and volcano emissions, as well as output variables such as greenhouse gas concentrations, global mean temperature, GDP growth, energy use and policy costs. The model relationships are intricate and include detailed nonlinear relationships describing interactions between the land, atmosphere, ocean and human activity. The model contains complex relationships, for example those comprising heat, material and balances for thirty three atmospheric components. Climate models are notoriously intricate and are often held up as examples of computationally intense applications.

Another example of an operation is the production of hydrogen for use as a source of energy. On the Catalytic Aspects of Steam-Methane Reforming, P. van Beurden, Energy Research Center of the Netherlands, December 2004 describes the nonlinear kinetic equations relating to the production of hydrogen. Life Cycle Assessment of Hydrogen Production via Natural Gas Steam Reforming, Pamela L. Spath et al., National Renewable Energy Laboratory, February 2001 lists other important operational modeling aspects related to hydrogen. Taken together, these publications describe a highly nonlinear process for manufacturing and distributing the commercially important commodity hydrogen. Detailed simulation models of such systems will include input variables such as feed gas flow, feed gas composition, raw materials costs, energy cost, reactor geometry, reactor temperature and pressure, catalyst costs and utilities costs. Simulation output variables will include stack emissions hydrogen product flow, hydrogen product composition, energy consumption, operating cost, transportation costs, final product costs and others. Depending on the level of rigor, hydrogen production and distribution simulations can contain tens or hundreds of thousands of nonlinear equations.

For purposes of brevity, from this point on, a representative oil refinery process will be used as an illustrative example of an operation. However, the following discussion applies equally to oil refining, climate modeling, hydrogen production and other areas which are the subject of nonlinear modeling.

An oil refinery converts crude oil into a number of commercially important products such as propane, gasoline, diesel fuel, jet fuel and asphalt. The situation is in fact more complicated than this, for a number of reasons. First, each of these products usually has multiple grades (e.g. low, medium or high octane gasoline; high sulfur or low sulfur diesel fuel). Second each product grade sells for a different price. Third, there are hundreds of different types of crude oils, each having its own unique set of properties, each having a price related to those properties, and each having availability which varies by time and location. Fourth, every oil refinery is unique, both in terms of geographical location and in terms of the types of “processes” used to convert crude oil into useful products. In the context used here, a “process” refers to a collection of refining equipment within the refinery, used to perform a specific task, such as separating crude oil, making gasoline and removing sulfur. Examples of processes include Crude Units, Catalytic Crackers, Catalytic Reformers and Distillate Desulfurizers. While a simple refinery can have as few as five processes, a more complicated one can have upwards of twenty different processes. In addition, each process can be run in many different modes or conditions. Finally, the individual products which the refinery makes have demands and product specifications which fluctuate significantly seasonally and annually. Gary and Handiwerk, published by Marcel Decker (1984) is an excellent reference, outlining the basics of oil refining.

The combination of these complicating factors—many available crudes, many products made, many processes, many operating modes and many prices—means that a refinery operator must constantly select the single “best” or “optimal” way to run the facility from a bewildering array of possible choices. Of the choices available to a refinery operator, some are not feasible (e.g. cannot pump more oil than the equipment constraints will allow) and many are very expensive (buy finished products from a competitor). The single best choice is the one which satisfies all of the finished product demands and specifications, honors all operational constraints, and does so at the highest possible profit to the refining company. Such a best choice is called the “optimal solution”, and is generally made available to the refinery owner through a technique referred to as “optimization.”

“Optimization” is a general term. In an oil refinery, the operating staff routinely use many kinds of optimization. Some of these include linear optimization of a single piece of operating equipment (heater, distillation column), non-linear optimization of a process unit (Crude Unit, Catalytic Cracker), non-linear optimization of product blending (gasoline, furnace oil), linear optimization of an entire refinery (Monthly Planning) and linear optimization of a group of refineries (Strategic Planning). All types of optimization have a number of common features, including a “process model”, a description of the “process constraints”, a definition of the “objective function”, a set of “model parameters”, “independent variables”, “disturbance variables”, “dependent variables” and a “mathematical solver.” A working definition of each term is provided here. For a more complete description of optimization concepts see Optimization of Chemical Processes, Edgar, Thomas F. and Himmelblau, David. M., McGraw-Hill (2001).

A “process model” is a mathematical description of all or part of an oil refinery. Such process models calculate the amount of finished product (gasoline, diesel) made by a modeled process, given a specific amount of raw materials (crude oil or intermediate products) and a set of operating conditions (temperatures, pressures, heating, cooling). Process models are generally based on the laws of chemistry and physics and keep accurate account of the material and energy flows, insuring that these obey the laws of nature (cannot create or destroy mass or energy). Process models represent the actual behavior of the process.

A “process constraint” or “constraint” represents the physical capability of a piece of equipment. A pump, for example, can only pump so much material; when the pump is running at maximum speed, it cannot pump more. In this condition, the pump is said to be at its maximum flow constraint. The process model insures that all of the equipment being modeled does not exceed minimum and maximum constraints on all flowrates, temperatures, pressures or compositions (e.g. gasoline octane, jet freeze point, ethane in propane).

An “objective function” is a way of quantifying how efficiently an operation is running. In an oil refinery, an objective function is often based on profit, which is calculated to be the value of all of the finished products made, minus the costs associated with the raw materials and energy used to make the products. If a given operation's objective function is profit, then the operation's optimum will be that set of conditions (raw materials used, energy consumed, products made, operating conditions) leading to maximum profit. There are other examples of objective functions including for example: minimize pollution, maximize a single product, minimize energy consumption and so on. Typically an objective function is comprised of independent variables, dependent variables and costs (or weighting factors) in some combination. The choice of the best objective function is left up to the owner of the operation.

“Model parameters” refer to a set of numbers which makes a general-purpose process model represent a unique oil refinery. An example of a model parameter is the size of a pump or the diameter of a pipe or how much jet fuel there is in a specific type of crude oil. The model parameters are set to make the process model match a given operation as closely as possible.

An “independent variable” is a variable in a model which can be set at a specific value by a person. A skilled practitioner often also uses the phrase “input variable” or “control” in place of “independent variable”. For a given operation, the set of independent variable values will determine the result of the model. An example of a typical independent variable for an oil refinery is the feedrate to a Catalytic Cracker.

A “disturbance variable” is a variable in a model which is fixed at a specific value by external factors. A skilled practitioner often also uses the phrase “feedforward variable” or “condition” in place of “disturbance variable”. For a given operation, the set of disturbance variable values will determine the result of the model. An example of a typical disturbance variable for an oil refinery is the ambient temperature.

A “dependent variable” is a variable which is calculated by the model. A skilled practitioner often uses the phrase “output variable” or “product” in place of “dependent variable”. The model calculates values for each of the dependent variables, based on the set of model equations, parameters and the values which were specified for the independent variables. An example of a typical dependent variable for an oil refinery is the gasoline product flow from a Catalytic Cracker.

By setting numerical values for the set of disturbance variables and the set of independent variables, a simulation model is said to be “fully specified”. Being fully specified means that the model has sufficient information available so that it can calculate values for all of the dependent variables.

A “mathematical solver” or “optimizer” is a technique for finding the optimum for a given process model, a given set of model parameters, constraints and objective function.

One way to view a process model is to compare it the terrain around a mountain. A mathematical solver can be compared to a mathematician issuing instructions to a hiker who wants to get to the top of the mountain (the optimum), which is hard to see because of tall trees. The mathematician searches for the optimum by instructing the hiker to take a step in a certain direction (this is equivalent to trying out a new operating condition in the process model). If by taking a step, the hiker has increased in altitude, the mathematician will likely tell the hiker to keep going in the same direction. If the hiker decreases in altitude, the mathematician will tell the hiker to try a new direction (new operating condition for the model). As the hiker makes progress, the mathematician builds up a general idea of the terrain in the vicinity of the hiker. The hiker may occasionally encounter a fence (constraint), and will be instructed by the mathematician which direction to try next to stay away from the fence and still keep going up. By this type of informed trial and error, the hiker will reach the optimal solution—either the mountain peak or the highest fence on the mountain.

There are many different kinds of process model. These can be broadly classified using the terms “linear”, “nonlinear”, “first-principles” and “reduced.”

A “linear” model is one in which the calculated results (e.g. finished products) depend only on linear combinations of the model's inputs (e.g. for a refinery crude oil, operating conditions). A very simple refining example of a linear model is:
Gasoline flow=0.5×Crude oil flow.

A “nonlinear” model is one in which the calculated results (e.g. finished products) depend on both linear and nonlinear combinations of the model's inputs (e.g. for a refinery crude oil, operating conditions). A very simple refining example of a nonlinear model is:
Gasoline flow=0.005×Crude oil flow x Crude oil temperature.
   This model is considered nonlinear because two of the model's inputs, crude oil flow and crude oil temperature, are multiplied together.

A “first-principles” model is one which contains a very detailed description of an operation being modeled. Even though the disclosed invention is applicable to any number of operations, it's helpful to consider a specific example related to oil refining. First-principles oil refineries models first came into use in the 1970s, around the same time the last oil refinery in the United States was built. For an oil refining operation, first-principles models are inherently nonlinear, having as a basis a set of detailed thermophysical hydrocarbon properties such as heat capacity, enthalpy, viscosity, vapor-liquid equilibrium and chemical equilibrium. The ASTM International reference manual AT029, ASTM International, Dec. 11, 2004 is a good example of such a set of thermophysical hydrocarbon properties. In a first-principles model, these hydrocarbon properties are used to construct all heat, mass and component balance relationships using known equations for various refinery process operations such as distillation, heat exchange and chemical reaction. First-principles models for oil refining, which are available on the open market, are as a general rule extremely complex, both in terms of the types and large numbers of equations they contain. A first-principles model for a single refinery process (e.g. Catalytic Cracking) will contains many tens of thousands of nonlinear equations. Modeling an entire refinery with a first-principles approach could require hundreds of thousands of equations.

The inherent complexity and size of such models makes them accurate over a wide range of operating conditions, as well as allowing the models to be very general. But accuracy and flexibility come with the price that such large models require special expertise to use and maintain, and the mathematical solvers used are themselves extremely complicated and prone to failure.

First-principles models can fail in a number of ways. One common failure is brought about by certain equation formulations which cause the mathematical algorithms to get lost during the search for the optimum. Using the previously-discussed example equating optimization to finding the top of a mountain, this type of failure would be the equivalent of ending up in outer space while trying to locate a mountain peak. When these types of failures happen, the usual end result is an arithmetic error such as a divide-by-zero or a numerical ambiguity such as infinity multiplied by zero. Unfortunately the underlying problems which lead to such failures can be extremely subtle and will often require a highly-skilled person to invest days or sometimes weeks to find the root cause. In addition to being numerically fragile, first-principles models are complicated by other factors. An example of these is a first-principles model which is based upon a number of interconnected simulation blocks. In a refinery, such blocks could be individual heat exchangers, distillation trays, valves, pumps and reactors. Some first-principles models will have dozens or even hundreds of interconnected blocks, so many in fact, that the connections themselves become a source or errors. A user who inadvertently connects blocks in the wrong sequence can spend days trying to diagnose the source of a questionable result. One final oil refining example of first-principles model complexity derives from the thermophysical properties calculations themselves- these can be significantly non-linear, discontinuous, or can have multiple solutions, all of which can lead to failure of a first-principles model to solve successfully.

Returning to the question of how a refinery operator might best optimize the operation, one approach is to use a Linear Program to simulate and optimize the entire refinery over a long time period, typically a month. Linear Programming was developed by IBM and its application to oil refining is well-documented in An Introduction to Linear Programming, IBM Technical Publications Department, White Plains New York, 1964. As one would expect from its name, Linear Programming is a based on a linear model of the operation. The practice of using Linear Programming to optimize refining operations is well established and widespread. Today most refiners routinely use a Linear Program once a month to select the best crude purchases and modes of operation for the current set of product demands, prices and operational constraints. The shortcoming of linear programming is that these models fail to capture significant nonlinearities in the operation.

Another optimization approach is to use a first-principles model to optimize part of a refinery. Although such applications are generally very complicated, they do account for nonlinearities inherent in the operation and therefore have the potential to increase profitability. It is at this level of optimization that a number of real-time applications are emerging in areas such as oil refining.

Krist, et al., in U.S. Pat. No. 5,486,995 teaches an approach to nonlinear real-time optimization with emphasis on accommodating the impact of changing costs on the objective function and the explicit use of Lagrange multipliers for optimization. As with all real-time optimization approaches, this one is based on a model, although in the case of Krist the type of model is entirely non-specific, being neither first-principles nor reduced. Furthermore, Krist requires that both the model and the process exhibit “steady state” behavior as a prerequisite for optimization. (The term “steady state” is defined as a process, or a model of a process, which exhibits no accumulation of mass or energy with time). The current invention disclosed herein places no restriction on the process or the model having to be based entirely on steady state. Neither does the current invention place any restriction of explicit use of a set of Lagrange multipliers being used to implement an optimal solution. Instead, any one of a number of optimization techniques can be used, as long as the technique has the potential to calculate a result closer to the optimum than the current operating point.

Hess, et al. in U.S. Pat. No. 6,826,521 shows a technique for using a first-principles (in his words, “rigorous”) model to develop a linear state space model for use in real-time predictive control. In this case, the first-principles model is used expressly to derive a linear state space model at a single operating point for the operation. A linear state space model is a very specific formulation, generally used for control of time-varying, or dynamic systems.

Another practitioner Beauford , et al. presents in U.S. Pat. No. 5,260,865 a method for using an approximate model (in his words, “shortcut”) as a way of controlling distillation processes in real-time. This shortcut model in this case is not derived from a first-principles model, but has a very specific formulation relating only to certain processes containing distillation of pure components.

In U.S. Pat. No. 6,735,483 Martin, et al., teach an approach to controlling a mill using a linear controller whose steady state gains are adjusted by a rigorous nonlinear model. In Martin's invention the rigorous model is used solely to adjust the steady state gains of the controller. Martin's method further utilizes a first principles model to improve the accuracy of a neural net controller which is outside of its training range. There is no mention of the concept of a reduced nonlinear model, nor is there any mention of using a first principles model for optimization in the absence of a linear dynamic controller. In Martin's usage a rigorous model can be viewed as an extension of the linear dynamic controller, and is not a general means for optimizing and analyzing the behavior of an operation. Martin, et al. claim like inventions in U.S. Pat. Nos. 6,839,599, 6,738,677, 6,625,501, 6,493,596, 6,487,459, 6,438,430 and 5,933,345; as does Piche, et al. in U.S. Pat. No. 6,278,899. With respect to the present invention, each of these foregoing share the similar shortcomings in that the rigorous model is used only to schedule the steady state controller gains; there is no notion of a reduced model; nor are there any mention of using a reduced model to further analyze the behavior of an operation at and around its optimal point.

In U.S. Pat. No. 5,692,158 Degeneff, et al. teaches a method for generating a reduced model for use in simulating the dynamic performance of electrical transformers. The reduced model described by Degeneff involves a very specific model reduction, based on an extension of Kron's work and includes specific methodology using the trapezoid rule integrated with Gear's integration technique for integrating stiff differential equations. The model reduction technique is to linearize the first-principles model at an instant in time, and then to reduce this linearized model. Because Degeneff's reduced model is linear, the model reduction technique is fundamentally different from one disclosed in the present invention. Furthermore, Degeneff does not suggest applicability in alternate areas.

In U.S. Pat. No. 5,950,158 Wang teaches a method of generating a plurality of reduced models from an initial model having a relatively large number of components. From the plurality of reduced models, the one with the highest score is selected as the one to be used in pattern recognition applications. The models used by Wang are categorically different from the ones discussed in the present invention. Wang's models can be considered approximations of a pattern, a sound for example, where there is no notion of material balances, energy conservation or other fundamental laws of nature. The models discussed in the present invention contain nonlinear relationships describing physical operations, where material and energy are preserved, and the dependent variable values of the operation modeled are calculated uniquely by the combination of model equations, model parameters and independent variable values.

In U.S. Pat. No. 6,349,272 Phillips teaches a method for modeling time varying systems and nonlinear systems using a reduced model. Phillips' approach is to carry out the model reduction by linearizing nonlinear differential equations into time-varying linear differential equations, effectively making reduced linear models. By contrast, the present invention explicitly seeks to create nonlinear reduced models, which are more general than linear ones. Furthermore, the Phillips method is primarily applied to electronic circuits, whereas the current invention can be applied to any operation which can be described by nonlinear equations relating dependent variable values to a set of independent variable values.

In U.S. Pat. No. 6,654,649, Treiber, et al. teaches a method for nonlinear optimization of a polymer operation. Treiber's method specifies that a first-principles model is used to optimize a linear dynamic controller of a polymer process. The present invention describes a method for constructing and deploying a reduced nonlinear model. Said reduced model has multiple optimization applications, these not specifically limited to polymer plants, nor requiring the presence of a linear dynamic controller. Furthermore the present invention describes a set of related applications based on a reduced nonlinear model, these enabling a deep understanding of the optimization solutions and behavior of the plant at and around the optimal point. In addition, the present invention is usable for a large class of operations, including any operation which can be simulated by a first-principles nonlinear mode.

Each of these foregoing approaches fail to address a number of key areas. None of them allows for the fact that a general first-principles model can be accurately represented over a wide operating range by a reduced nonlinear model of proper formulation. Of primary importance is the fact that reduced models disclosed here are by nature general, not being confined to any particular type of operation, system or equation structure.

In the case of Beauford, the described method is only for use in simulating distillation systems using a specific type of shortcut model. In the case of Treiber, a rigorous model is used specifically for polymer plant optimization. Degeneff's claims relate primarily to the dynamic simulation of electrical transformers, using a specialized linearized reduced model. By contrast, the claims made here are general in nature, allowing the optimization of any operation which can be described by a first-principles model. Note that while oil refining is here being used as an illustrative example, the generalized reduced model can be used for any operation for which a nonlinear first-principles model is available.

There are a number of important merits in having available a reduced model of an operation. Among these are that reduced models while quite accurate, are by virtue of their simplicity inherently reliable, not being subject to the numerical frailties of their more complicated first-principles cousins. Also, because the reduced models are small, they can be made to solve extremely quickly, orders of magnitude faster than first-principles models. Reduced models have a much smaller computational burden than do the first-principles models from which they were derived. Finally, there are practical considerations, the main one being that complicated technologies usually require significant investments in time and manpower for maintenance, where, by contrast, simpler reduced model-based technologies require proportionately less effort.

The present invention directly addresses these needs and provides other advantages. For example, one can envision using a reduced model for optimizing any number of important operations—from aircraft performance to hydrogen production to steel production to environmental emissions to energy distribution. In addition, reduced models can be applied to the optimization of larger systems, replacing for example, the current practice of using the linear models (Linear Programming) to optimize an entire refinery on a monthly basis.

### OBJECTS AND SUMMARY OF THE INVENTION

The present invention relates to a method and apparatus for producing and subsequently applying a reduced model. A “reduced model” is a nonlinear model which can be used to simulate an operation, an oil refinery being one such example. Whereas a first-principles model is based on a deep scientific understanding of chemical and physical principles, a reduced model is based on a simplified representation of a first-principles model. In effect a reduced model is a model of a (first-principles) model. The reduced model, which may consist of a few tens or hundreds of equations is constructed so that its prediction will provide nearly the same results as a first-principles model, for a specific set of model variables. While a well-constructed reduced model obeys basic physical laws (e.g. mass in equals mass out, energy in equals energy out), it need not have any detailed knowledge of thermophysical properties, equations of state, chemical equilibrium or the like. By way of illustration, whereas a first-principles model might require 20,000 equations to calculate the gasoline flow on a specific refinery process, a reduced model might require only 20 equations to get a similar result.

The reduced model is an accurate nonlinear representation of a first-principles model over an operating range. Using the example of an oil refinery process, an operating range is defined by the range for the model's input variables—for example, feed rate, feed composition, temperatures, product flowrates, pressures and compositions (e.g. gasoline octane). Using an environmental example, an operating range might be defined as the range of waste flows to a furnace, furnace temperatures, pressures, air flows and stack emissions (CO2, NOx, SOx, particulates). For an aircraft optimization, an equivalent set of variables of interest could be air density, angle of attack, wing shape, air temperature, angle of yaw, airspeed and fuel consumption.

The creation of a reduced model begins by obtaining a first-principles model of the operation of interest, and fitting the first-principles model adequately to the operation, by means of adjusting the model's parameters, such practice being well-known to those skilled in the art. Next, the set of variables of interest for the problem to be optimized is selected. Each of the variables is fixed at a nominal or base case value and the first-principles model is then solved at this base operating point. A predetermined number of runs of the first-principles model is next made, by perturbing each individual independent variable of interest a number of times in order to span the operating range. In addition, independent variables are perturbed in pairs or in groups to obtain further nonlinear information characterizing the operation.

Next, the resulting set of previously stored solutions of the first-principles model is used to build a reduced model, whose form and structure have been decided in advance. This model building step seeks to make the reduced model match as closely as possible, the first-principle model over the operating range of the first-principles model runs.

The model fitting step is carried out using statistical approaches such as regression by least-squares, Principal Component Analysis (PCA) and Projection to Latent Structures (PLS). Practitioners skilled in the art will recognize techniques such as PCA and PLS as familiar ones for analyzing relationships between sets of variables. An excellent reference for these and other data modeling techniques can be found in Erikson, Johansson, Kettaheh and Wold, Umetrics (2001).

Once built, the reduced model can be applied in a number of ways. It can, for example be used to optimize an operation in real time. The scope of the optimization depends on the scope and the structure of the reduced model which has already been built, which in turn depends on the needs of the operator. A reduced model can also be used to optimize an entire refinery once a month (replacing the current Linear Programming approach) or it can optimize only a part of a refinery (e.g. Catalytic Cracker) on a more frequent basis, such as once every few minutes.

There are other applications of a reduced model. One such example is for visualizing how a given operation works. For example, an operator of an operation might be interested to know what direction to move reactor temperature in order to make more product, less waste or more money. Another way to use the reduced model is to visually describe the economics of the operation over some range in order to determine the best feeds to buy, best products to make or best operating conditions, for a given set of constraints and economic driving forces (prices).

One additional way to use a reduced model is as a tool to calculate and document the benefits of optimizing an operation. In the present invention, these benefits are characterized by the difference between optimizing an operation with a nonlinear optimizer as compared to optimizing the same operation using a linear optimizer. This type of analysis is of interest for example, to a someone running an operation that has an existing linear optimizer in place, but wants to understand how much better a nonlinear optimizer is. Because the reduced model is compact and fast, it can readily be used to compute both the nonlinear optimum and a linear optimum using the same constraints and objectives, and then display the differences in the solutions to the operator.

These and other features and advantages of the invention will be more readily apparent upon reading the following description of a preferred exemplified embodiment of the invention and upon reference to the accompanying drawings wherein:

### BRIEF DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a block diagram showing at a high level the method of constructing and deploying a reduced model, along with specific applications of the invention. It is presumed that a first-principles model of the operation is available, and that it can be calibrated, such practice being well-known to a skilled practitioner.

FIG. 2 is a block diagram showing in more detail the steps involved in constructing a reduced model.

FIG. 3 is a flow chart showing the use of a reduced model for real-time optimization.

FIG. 3a is a block diagram further illustrating the use of a reduced model for real-time optimization.

FIG. 4 is a block diagram showing applications of a reduced model for; (a)analyzing graphically the effect of costs and constraints on the optimum, (b) analyzing graphically the optimal behavior of the operation and (c) producing a set of operating instructions based on the optimal operation.

FIG. 4a depicts an example of the graphical results for analyzing the effects of costs and constraints.

FIG. 4b depicts an example of the graphical results for analyzing graphically the optimal operation.

FIG. 4c depicts an example of the graphical results for displaying a set of language-based operating instructions based on the optimal operation.

FIG. 5 is a block diagram showing the steps required to calculate the nonlinear optimization benefits.

FIG. 5a depicts an example of the graphical results for displaying the nonlinear optimization benefits.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

It is initially noted that the present invention will be implemented preferably in software for use with any general purpose computer having a CPU, memory, an input device (keyboard) and a display device (CRT). Said computer is capable of performing the software operations described below. The invention can be viewed as a general purpose computer which is operated in accordance with programming incorporating the invention. Since computers of the type necessary to perform the operations described below are known, no further detailed description is made herein. Similarly, since software languages capable of performing the operations described below are known, no further description is necessary.

In this discussion, an example of a specific refining process, a Catalytic Cracker, will be used throughout for clarity of illustration. The use of a Catalytic Cracker in the discussion in no way limits, however, the applicability of the invention to this single illustrative example. Gary and Handiwerk, Marcel Dekker (1984) contains an excellent reference describing the specific operation of a Catalytic Cracker as well as a general description of the principles of oil refining.

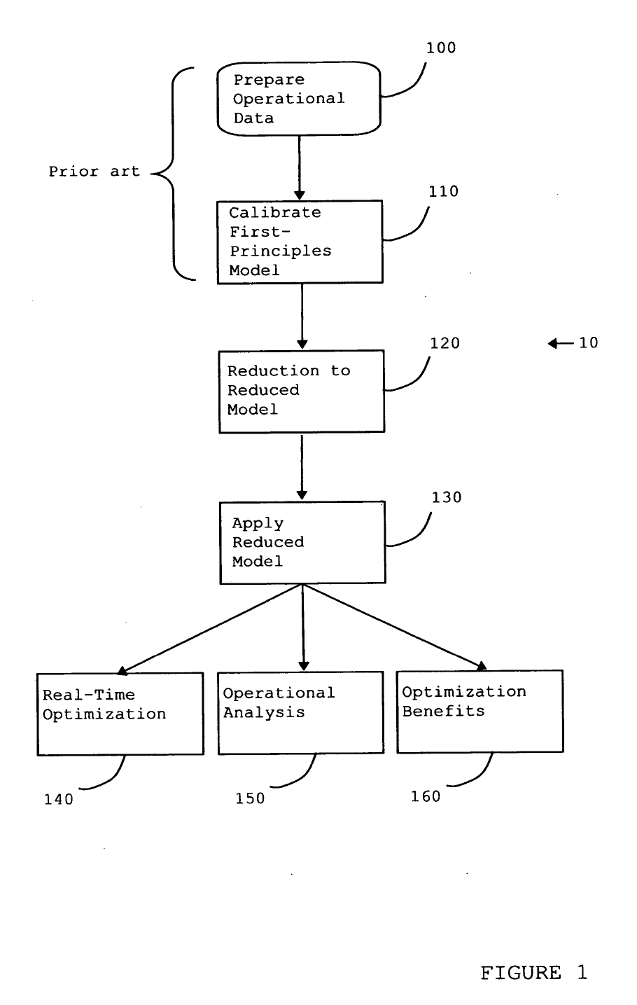

Referring to FIG. 1, a series of steps leads to the production of a reduced model, which itself enables a number of specific applications, three of which are discussed.

The method for producing a reduced model begins with data preparation step 100. In this context, data is defined to mean at least one measurement of a variable which in some way characterizes the operation being modeled. More typically, data refers to tens or hundreds or even thousands of measurements characterizing the operation, each measurement being representative of physical quantities of an operation. In a Catalytic Cracker, for example, the data may consist of the flows, temperatures, pressures and compositions of the raw materials entering the operation, and the finished product flows and properties leaving it. In addition, the data may include measurements which characterize the process, including equipment sizing, machine speeds, steam consumption/production, electricity consumption/production, cooling water availability, valve positions, ambient conditions and other similar measurements. Data preparation step 100 includes the removal of bad values and noise from the data, using techniques which are familiar to a skilled practitioner, such as data averaging, data filtering and outlier removal using statistical techniques.

Calibration step 110, familiar to a skilled practitioner, involves the first-principles model being “Calibrated” to the data, to make it match a specific set of measurements from the operation. This calibration step is accomplished by forcing the first-principles model to match the operating data by way of automatic adjustment of model parameters. Using the Catalytic Cracker example, the feed flow and composition measurements to, and the product flows and composition measurements from the Catalytic Cracker will be held constant during the first-principles model calibration step. Internal model parameters, such as rates of reaction and equipment efficiencies, will be automatically calculated by a mathematical technique to force the model results to match the Catalytic Cracker measurements, while simultaneously satisfying all of the model equations. Once calibrated, the first-principles model is generally thought to be the accurate representation of the operation being modeled.

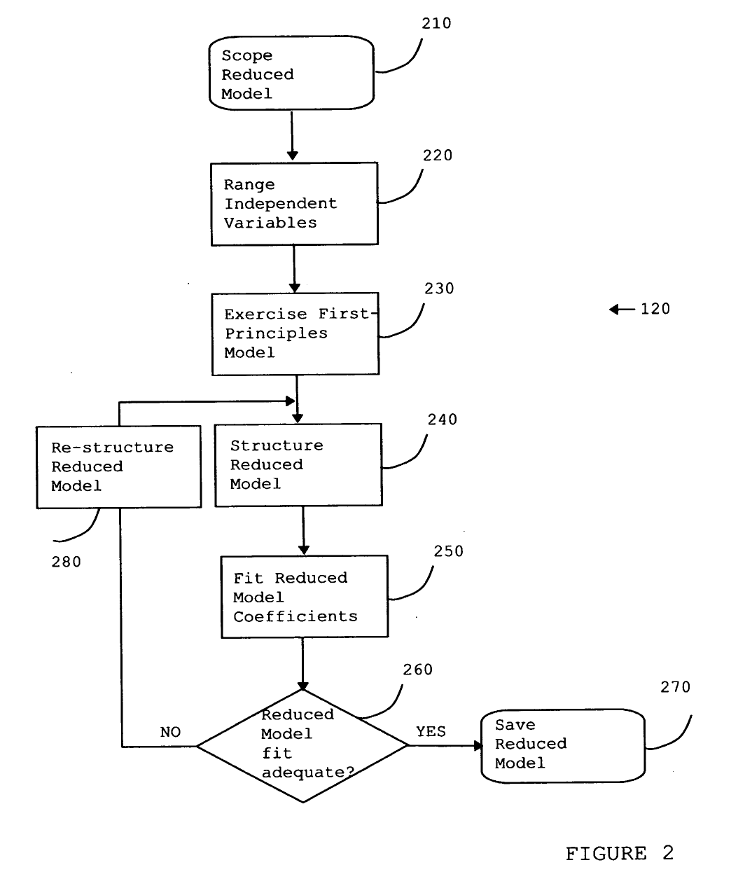

Model reduction step 120 begins with deciding on a scope for a reduced model, followed by deciding on a structure for a reduced model. Next the reduced model coefficients are derived using results from the first-principles model. This model reduction step is described in more detail in conjunction with FIG. 2.

Application step 130 is illustrative of a reduced model being applied. The reduced model comprises a set of equations and model coefficients, along with an apparatus for generating and viewing various types of results from the reduced model. During Application step 130, a user selects which specific application of the reduced model is to be performed. A Catalytic Cracking example of a reduced model is provided in conjunction with FIG. 2.

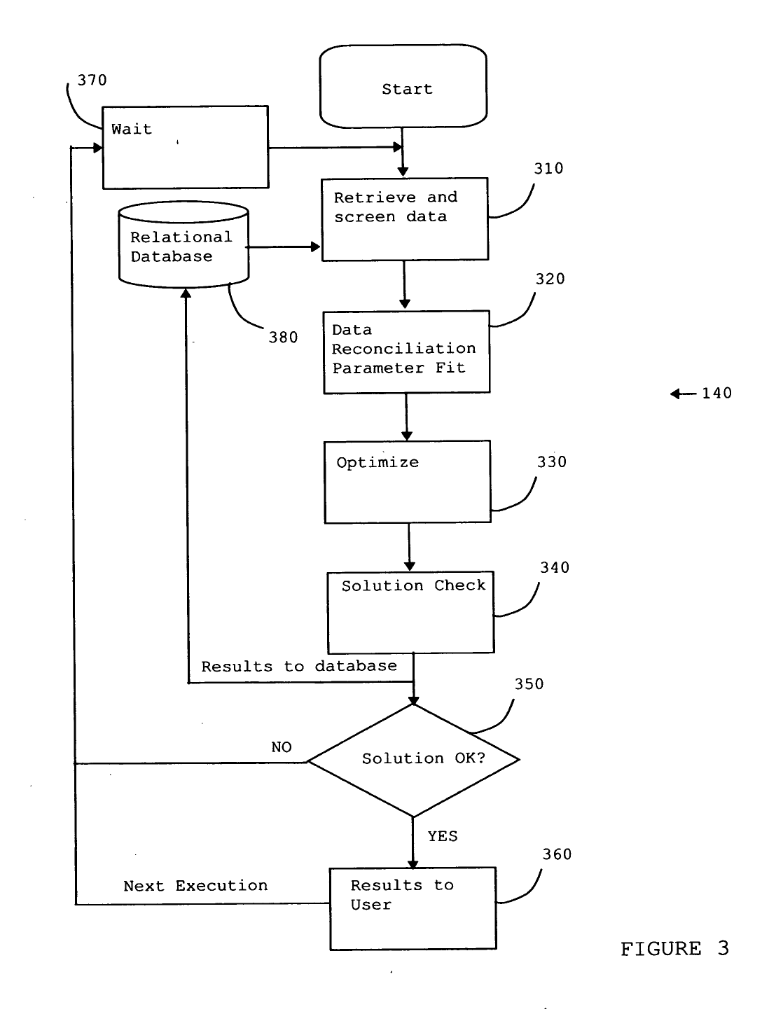

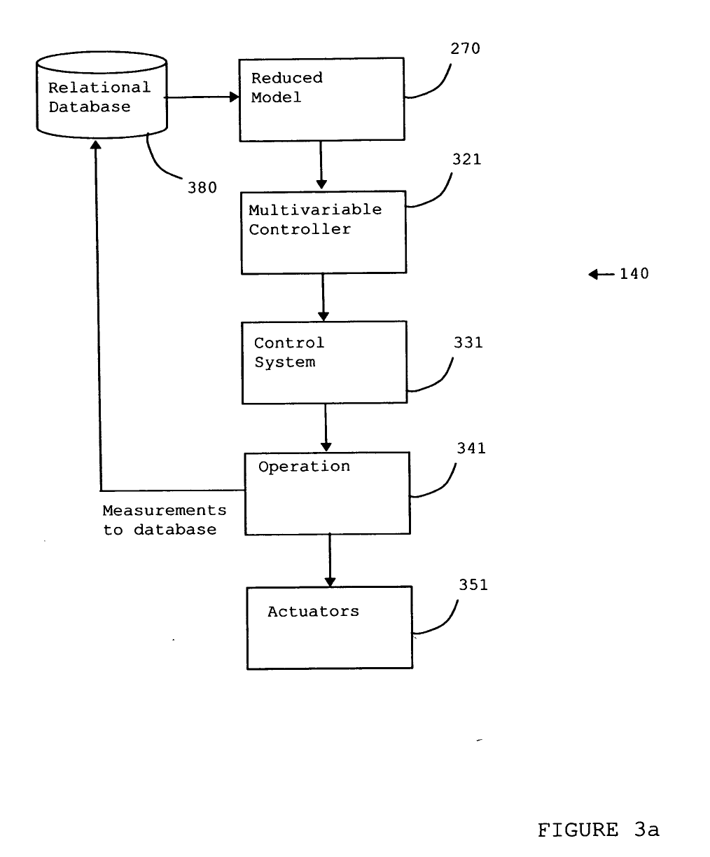

Real-time optimization step 140 embodies a specific application of the reduced model, which is further described in conjunction with FIG. 3.

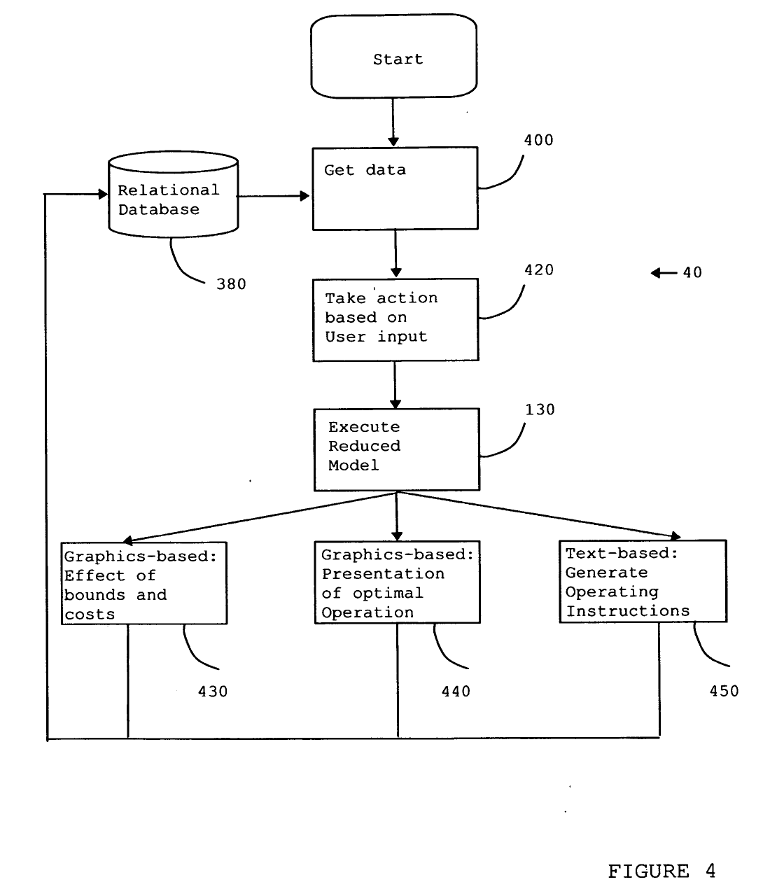

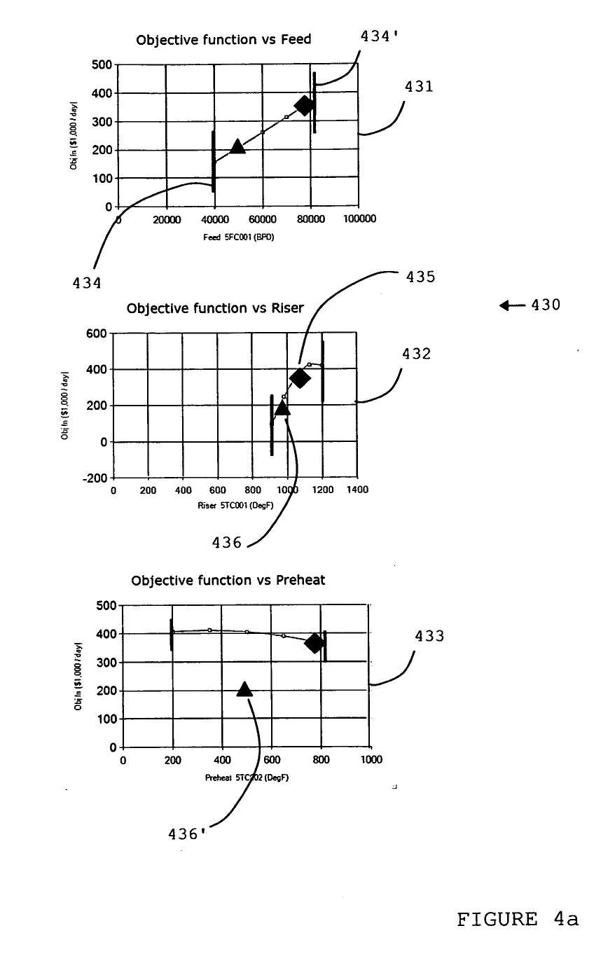

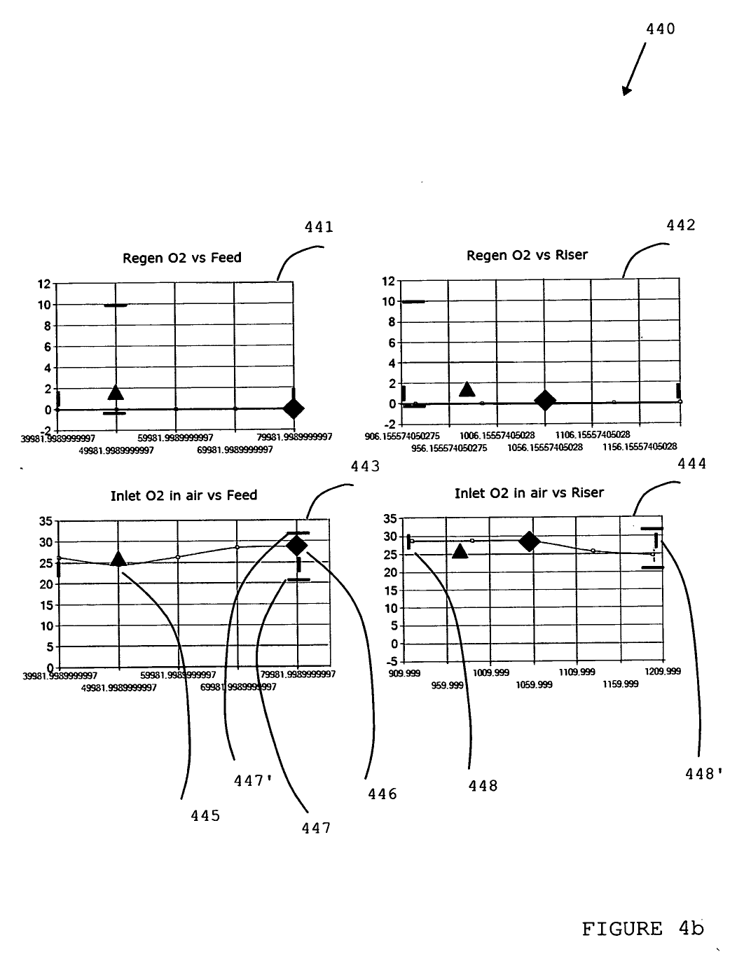

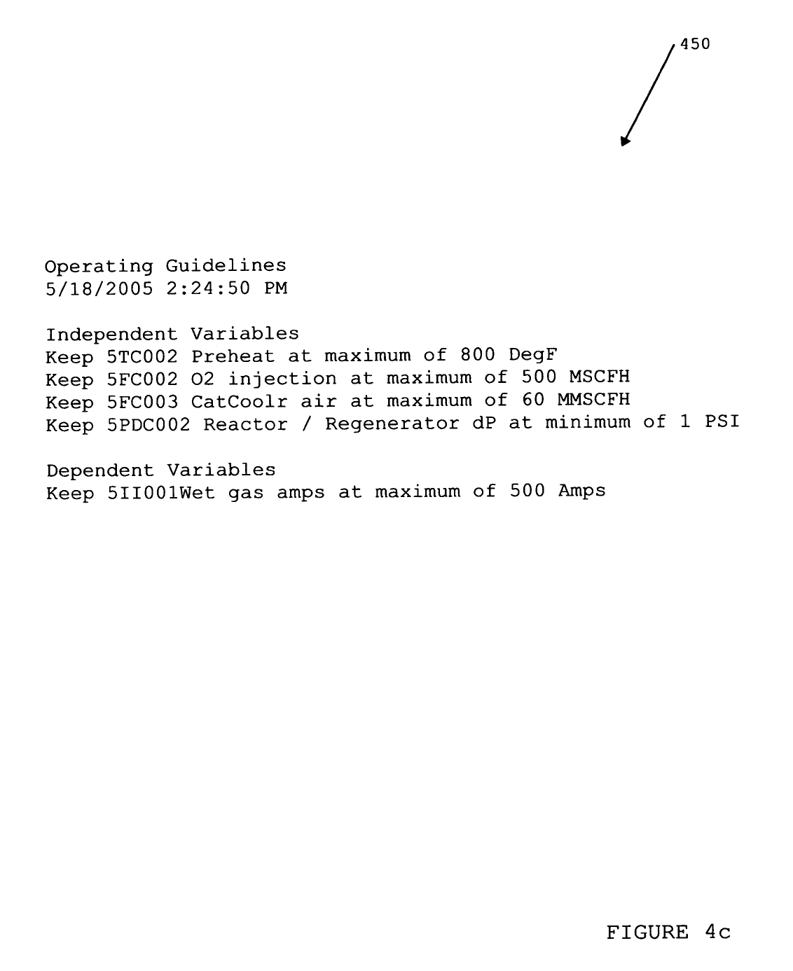

Operational analysis step 150 embodies another specific application of the reduced model, which is further described in conjunction with FIG. 4.

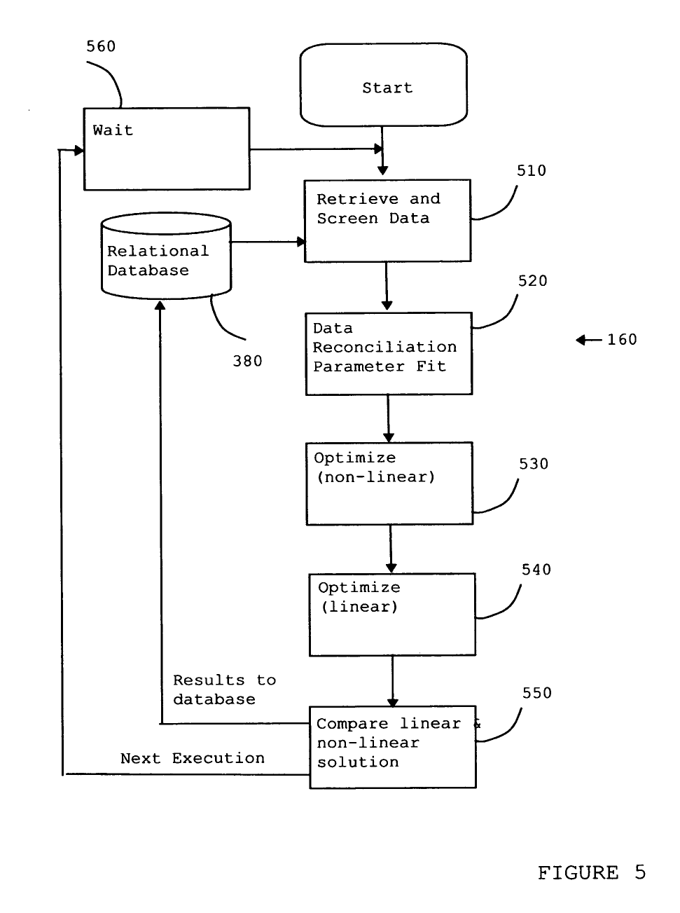

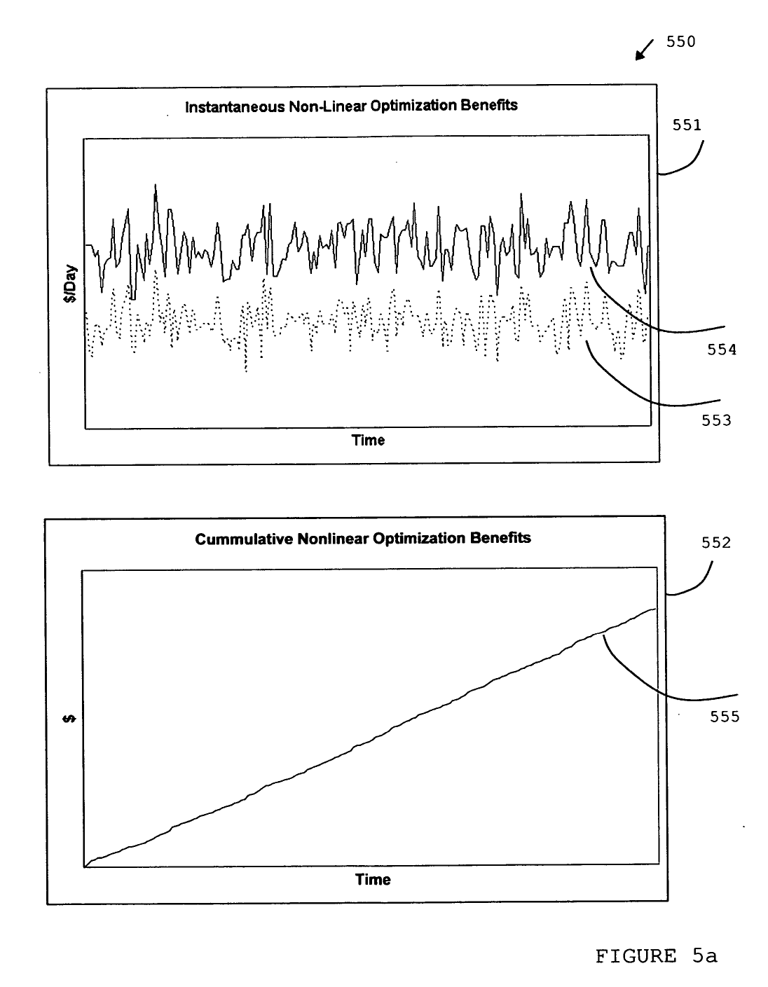

Optimization benefits step 160 embodies another specific application of the reduced model, which is further described in conjunction with FIG. 5.

FIG. 2, is the detailed description of the model reduction step. Scoping step 210 defines a suitable reduced model scope. The scope of a reduced model will be some portion of the operation being modeled by the first-principles model. This step requires that a set of input and output variables is defined for the reduced model, along with the decision of how much of the physical operation should be included in the reduced model. An example model scoping of realistic complexity is illustrated in Appendix B. For discussion purposes a simplified example is presented here. Using a Catalytic Cracker as an example, typical input variables may include feed rate, feed composition, feed temperature, reactor temperature, reactor pressure, product flow rates and stream costs. Typical output variables may include product compositions, flue gas compositions, operating temperatures, energy consumption, energy production, operating costs and operating profit. The choices of which variables to include and which parts of the process to include are dictated by the physical boundaries of the problem to be solved. For a Catalytic Cracker, the physical boundaries might include feed blending and parts of downstream process units. Whether to include the feed blending and the downstream unit operations are decisions which depend on the importance of these to the optimal operation of the Catalytic Cracker.

Another factor in selecting which variables to include in the reduced model is to select only those from the first-principles model which have a material impact on the problem being optimized, such determination made by a practitioner skilled in the art. For this reason, the number of variables in the reduced model is fewer than the number of variables in the first-principles model.

Ranging step 220 defines a procedure for setting up the first-principles model to generate results. Numerical values for the upper and lower limits for each independent variable are assigned. In setting these upper and lower limits it is important to make sure that the entire feasible range of the operation is spanned or exceeded. Using the Catalytic Cracker example, although the Catalytic Cracker may only be able to feasibly process 19,000 barrels per day of feed, the upper limit for the model runs would be set to a higher number such as 25,000 barrels per day. Doing this ensures that the resulting reduced model will have the ability to accurately predict over the operating range, without the risks associated with extrapolating nonlinear functions outside of the data range used to generate them. After setting the upper and lower limits for each independent variable, a set of prescribed values for each individual independent variable is determined. A term of art for this part of the ranging step is “Design of Experiments”, which is a term used by statisticians describing how best to set independent variables to efficiently extract information from an operation. This “Design of Experiments” comprises list showing the values of all of the input variables to be held constant for each of a number of runs to be made of the first-principles model. For each set of input variables, the first-principles model is solved once, and the solution recorded for later use. During ranging step 220, each individual input variable will be set to at least two different values, with a corresponding run of the first-principles model made for each value, while holding all of the other input values constant. One value for each input variable will be at its lower extreme and the second value for each input variable will be at its upper extreme—the extremes spanning the expected operating range of operation for that input variable. Input variables will also be varied in combinations of twos, and threes (higher combinations are also possible) in order to span the full nonlinear space of the operation of interest. Whether to vary independent variables in pairs or other combinations is decided by a practitioner skilled in the art, through an understanding of which are the most important independent variables, and which combinations of independent variables are likely to lead to important nonlinear effects. Note that it is only necessary to arrive at an approximate set of combinations for independent variables at this stage, because these combinations will be refined later during an iterative procedure involving Re-structuring step 280, described below.

In an alternate embodiment the ranging step (including Design of Experiments) is applied to a dynamic first-principles model, where the term “dynamic” indicates that the model includes relationships which vary over time. The ranging and Design of Experiments steps for a dynamic model are similar to the above description, as is known to practitioners skilled in the art.

Referring to Model Exercise step 230, the first-principles model is “exercised” or run a number of times, to cover the range and combinations of variables selected. Using the Catalytic Cracker example, the input variables for a set of runs for the Design of Experiments might look as follows:

TABLE 1
Example Design of Experiments for a Catalytic
Cracker

Independent Variables

| Model run | Feed rate | Reactor Temperature |
|---|---|---|
| 1 | 1,200 (Base) | 900 (Base) |
| 2 | 1,000 (Low) | 900 (Base) |
| 3 | 1,400 (High) | 900 (Base) |
| 4 | 1,200 (Base) | 800 (Low) |
| 5 | 1,200 (Base) | 1,000 (High) |
| 6 | 1,000 (Low) | 800 (Low) |
| 7 | 1,400 (High) | 1,000 (High) |
| 8 | 1,000 (Low) | 1,000 (High) |
| 9 | 1,400 (High) | 800 (Low) |

At the conclusion of the model runs, there will be recorded nine sets of first-principles model results. In addition to values for each of the input (independent) variables, each result will include values for all output (dependent) variables, such as product flowrates, compositions and energy usage.

Structuring step 240 prescribes a set of equations that relates each reduced model dependent variable to one or more independent variable. The intent of selecting a reduced model structure is to identify a compact, robust, accurate set of equations to represent the first-principles model results. Each dependent variable is a nonlinear function of one or more independent variables, either individually or in combination.

The procedure for selecting the independent variables to be used for each dependent variable equation begins with visually analyzing the first-principles models results, where each dependent variable is plotted against each independent variable on an x-y plot. Where a correlation is found between a dependent variable and an independent variable, that independent variable is added as a term in the equation structure for that dependent variable. In cases where the dependent versus independent variable x-y plot also shows nonlinearity, appropriate nonlinear independent variable terms are correspondingly included in the equation structure. Principle Components Analysis (PCA) and Projection to Latent Structures (PLS) are additional techniques which a skilled practitioner may use to explore underlying relationships between dependent variables and independent variables, in order to arrive at appropriate equation structures. A further step of identifying equation structure is based on an understanding of the operation being modeled, wherein it would be known to a practitioner skilled in the art that a dependent variable depends on certain documented nonlinear combinations of independent variables. One example of this would be an equation for fluid flow in a pipe, where it is well-known to those skilled in the art that fluid flow is related to the square root of pressure drop by Bernoulli's equation.

The model structure is further selected in order that basic laws of physics and chemistry are obeyed, for example that mass, energy and composition balances are preserved. The motivation for preserving material and energy balances is so that when the reduced model is later used in an optimization environment, the optimizer will not exploit small material or energy imbalances in an attempt to improve the operation. At this stage, each equation will have incorporated into it a set of model “parameters”, which will become important later, in matching the reduced model results to an operation in real-time.

Using the Catalytic Cracking example, a simple reduced model structure is shown in Equation 1:

$$\begin{matrix}Gasoline Flow = B 1 + \\ B 2 * Reactor Temperature + \\ B 3 * Feed Rate + \\ B 4 * Reactor Temperature * Feed Rate\end{matrix} \qquad Equation 1$$

where B1, B2, B3, B4 are reduced model coefficients; Reactor Temperature and Feed Rate are input (independent) variables; and Gasoline Flow is an output (dependent) variable.

To illustrate, an alternate candidate reduced model structure is shown in Equation 2:

$$\begin{matrix}Gasoline Flow = B 1 + \\ B 2 * Reactor Temperature + \\ B 3 * Feed Rate + \\ B 4 * Feed Rate * Feed Rate\end{matrix} \qquad Equation 2$$

Using the variables shown in Equations 1 above as an example illustrates how the structuring step is carried out in practice. (Appendix B contains a more detailed illustration of this step 240, as well as other steps shown on FIG. 2). After the fist-principles models runs have been carried out, a record of the results will exist containing gasoline flow at different combinations of feed rate and reactor temperature. Plotting gasoline on the y axis of an x-y plot versus feed rate on the x axis, and also versus reactor temperature on the x axis of a second plot, shows that gasoline flow increases as feed rate increases, as well as that gasoline flow decreases as reactor temperature increases. Because there appears to be a relationship, at least visually between gasoline flow and feed rate and reactor temperature, both feed rate and reactor temperature will be included as independent variables in the gasoline reduced model equation. In addition, gasoline flow is plotted versus feed rate squared, reactor temperature squared and feed rate times reactor temperature. If, out of these three plots, there appears to be a relationship between gasoline flow and feed rate squared, then feed rate squared will be included in the gasoline equation. Other combinations of plots can be tried as well—for example gasoline versus the reciprocal of feed rate or the reciprocal of reactor temperature. In selecting these additional x-y plots, the skilled practitioner uses an understanding of the physical process as a guide. When a set of independent variables (both individual variables and nonlinear combinations) has been selected, the practitioner moves on to the next step in the procedure—Fitting step 250.

The purpose of Fitting step 250 is to calculate numerical values for the reduced model coefficients, in order to make the reduced model results match the first-principles models results, which were stored at the end of Exercise step 230. This fitting step is substantially a statistical one, relying on data modeling techniques such as those found in Eriskon et al (see above). The general mathematical problem to be solved at this step can be summarized by the following equation:
Minimize Σ_{1-N}[Σ_{1-M}(Y−f(X,B))²] Equation 3
Where,
B=Set of reduced model coefficients
K=Number of reduced model independent variables
M=Number of first-principles model runs
N=Number of reduced model dependent variables
X=First-principles independent variables
Y=First-principles dependent variables
F(X,B)=Estimated reduced model output variables

Equation 3 seeks to minimize the error between all (N) of the reduced model calculated dependent variables (f(X,B)) and the first-principles output variables (Y) over all the first-principles model runs which were made (M). One common method of implementing Equation 3 in practice is to use an algorithm which solves a least squares problem, an example of which can be found in Microsoft's Excel spreadsheet software. In Excel 2002, this function can be invoked through: the Tools menu, then Data Analysis, then Regression. In setting up problems such as shown in Equation 3, it is important to consider independent and dependent variable scaling. Scaling is a way to ensure that all variables have the same relative importance. One way to scale a problem is to divide each independent and each dependent variable value by that variable's base value, before carrying out the coefficient fitting step. When scaling a problem in this way, all variables have values close to 1.0. After the reduced model coefficients have been calculated, these are then “un-scaled” by multiplying them by their base values, and by the appropriate dependent variable base values.

The quality of the reduced model fit as quantified by Equation 3 is evaluated as represented Checking step 260. If the model fit is judged adequate, the reduced model is finished. One common way to measure model adequacy is to consider the “R-Squared” value for each dependent variable. Used in this context, the R-squared value is interpreted to mean how well a reduced model dependent variable matches its corresponding first-principles model dependent variable over the range of the model results. Using the Catalytic Cracker example, if the reduced model gasoline flow matches exactly the first-principles gasoline flow for all model runs, then the R-squared of the reduced model gasoline flow is 1.0. Using this criterion, or a similar one, if the model fit is judged to be inadequate, Re-structuring step 280 is carried out, and the model fitting sequence is repeated. If the model fit is judged adequate, the reduced model coefficients and structure are saved as in step 270.

In model re-structuring step 280, the reduced model residuals are analyzed for each dependent variable (“residual” means the first-principles model result minus the reduced model result for a dependent variable). The residuals are compared against independent variables or nonlinear combinations of independent variables, either visually (x-y plots) or using statistical techniques familiar to a skilled practitioner (e.g. cross correlation). Where significant relationships are suspected between the residuals and independent variables, these independent variables are included as additional terms in the dependent variable equations. Conversely, variables (or combinations of variables) may be dropped from the equations during Re-structuring step 280. One common way of deciding whether to drop an independent variable from a dependent variable equation is to examine the confidence limits on the coefficient associated with the independent variable. (“Confidence limits” are commonly computed during least squares fitting, and are routinely used by skilled practitioners in analyzing regression model coefficients). Using a Catalytic Cracker example, the lower and upper 95% confidence limits for the coefficient B3 in Equation 2 might be calculated as −1.1 and +1.3. This means that there is a 95% chance that coefficient B3 is between −1.1 and 1.3, a range which includes 0.0. Or, in other words, the coefficient B3 is likely to be 0.0, meaning that gasoline flow does not depend on feed rate (it could still depend on feed rate squared, assuming that coefficient B4 in Equation 2 is not 0.0). An alternate description for model restructuring step 280 is “function replacement” step 280.

The method of identifying the reduced model structure and coefficients described above is part of an iterative process which includes Structuring step 240, Fitting step 250, Checking step 260 and Re-structuring step 280.

One of the applications of a reduced model is real-time optimization and is shown in FIG. 3. The sequence begins with Retrieval and Screening step 310, where the data required to execute the reduced model are retrieved from Relational Database 380. These data consist of reduced model coefficients, reduced model equations, values for all of the reduced model independent and dependent variables, model parameters, variable limits, as well as whatever economic costs are associated with the optimization objectives. For a Catalytic Cracker the independent variables will include such measurements as feed rate, feed composition, reactor temperature and reactor pressure. Dependent variables will include such measurements as product flowrates, product compositions and energy used. Economic costs will include such measurements as feed cost and product costs. The phrase “real-time” indicates that the model measurements are changing fast enough and significantly enough that the optimum of the operation is continually moving. Unless some deliberate and frequent action is taken to change the way the operation is running, it will be continually performing in a sub-optimal way. For example, for a Catalytic Cracker, constantly varying feed compositions, or weather, or product values may require that the reactor temperature is constantly adjusted in order to keep the operation as close as possible to the rapidly moving optimum.

Operational data usually contain measurement noise and bad values. These bad values have many sources including; limited repeatability and reproducibility of automated and manual measurements, failure of instrumentation and unmeasured disturbances in the operation. Part of Retrieval and Screening step 310 is to remove such bad and noisy measurements from the raw data. Data screening involves a combination of statistical techniques (e.g. PLS) and heuristics (e.g. checking raw data against reasonability limits). Data which fail such reasonableness checks are filtered for noise removal, discarded and replaced with estimates, or replaced with surrogate measurements.

Screened data are used as the basis for Parameter Fit step 320. The most general algorithmic presentation of this fit step is given by Equation 4:
Minimize Σ_{1-N}[(Y′−f(X′,B′))²] Equation 4
Where,
B′=Set of reduced model parameters
N=Number of reduced model dependent variables
X′=Screened reduced model independent variables
Y′=Screened reduced model dependent variables
f(X′,B′)=Estimated reduced model output variables

Equation 4 states that the reduced model calculated dependent variables (f(X′,B′)) are made to match as closely as possible the measured and screened dependent variables (Y′). This is accomplished by solving for reduced model parameters (B′) via an optimization problem. Such problems are frequently referred to as “Data Reconciliation” problems.

An alternate and simpler formulation for the model fitting problem of Parameter Fit step 320 is stated as equation 5:
B″=Y′−f(X′) Equation 5
Where,
B″=Subset of reduced model parameters
X′=Screened independent variables
Y′=Screened dependent variables
f(X′)=Estimated model output variables

Equation 5 states that the reduced model parameters (B″) are simply calculated as the difference between the screened dependent variables (Y′) and the reduced model calculated dependent variables (f(X′)).

Both formulations of the model fitting problem require the availability of the reduced model, which is stored in Relational Database 380 as model coefficients and equations. In the data fitting step, both the model parameters (B′ or B″), and the model output variables (F(X′,B′) or F(X′)) are calculated by an optimization algorithm, such as can be found in Fletcher (1987) or Gill, Murray, Wright (1981).

An illustrative example will help in explaining the differences between the two parameter fits given by Equation 4 and Equation 5. Assume that the operation being modeled can be represented by a parabola on an x-y plot. Since the reduced model represents the operation, its shape is also a parabola. However, since the operation is a real-time one, its location and shape will evolving slightly over time, based on what is happening to the measurements in the operation. This means that at any moment in time the reduced model may not match the operation (parabolas will have different vertical locations on the x-y plot, and will have different slopes). Equation 5 seeks to shift the reduced model's parabola vertically up or down to get it as close as possible to the operation's parabola at any given moment in time. Equation 4 on the other hand not only moves the reduced model's parabola up or down vertically, but also changes the “slope” if its parabola to more closely match the operation's parabola at any given moment in time. In both cases, the reduced model's parameters are therefore fit to make the reduced model match the plant.

The reduced model, now possessing a set of parameters reflecting current operation, is used to improve the operation, as shown in Optimize step 330. The optimization problem can be stated mathematically as in Equation 6:
Minimize J(x)
Subject to Zᵢ(x)=0, i=1,2, . . . , m′;
zᵢ(x)>=0, i=m+1,2, . . . , m. Equation 6
Where,
J(x)=Objective function of the optimization
x=Independent and dependent variables
zᵢ(x)=Constraints (equality=0, inequality >=0)
m′=Number of equality constraints
m=Number of inequality constraints

Equation 6 is the “NCP” formulation described by Gill as the most general form of an optimization problem. What Equation 6 says in words is: “Find that set of independent variables (subset of x) which minimizes the nonlinear objective (J(x)), while honoring nonlinear constraints in the dependent variables (subset of x which is not independent variables). There are two types of constraints; those for dependent variables with equality constraints, whose values have an exact value at the solution; and those for dependent variables with inequality constraints, whose values are greater than some limit.” For a Catalytic Cracker, J(x) could be operating profit in $/day (actually would be negative operating profit, since the algorithm seeks to minimize it). Similarly for a Catalytic Cracker, x would consist of both independent variables (Feed Rate, Feed composition, etc.) as well as dependent variables (Product rates, etc.). An example of an equality constraint would be that the excess stack oxygen is equal to 2.0%. An example of an inequality constraint would be that the gasoline product flow is greater than 1,000 barrels per day. As before, the reduced model is used to supply the dependent variable values to an optimization algorithm similar to that used in the parameter fit described previously.

Referring to Solution Check step 340, the optimal solution is checked for reasonableness using rules of thumb and heuristics. These checks are designed to insure that the optimal solution does not exceed any physical limitations of the operation (e.g. temperatures, pressures, flows for a Catalytic Cracker), as well as insuring that the operational variables have not moved significantly during the solution time of the optimizer. After the solution check, the results of all the calculations and data activities performed up to this point are stored back into Relational Database 380 so that users and other applications can have access to these.

Decision step 350 is made based on Solution Check 340. If successful, the optimal solution is made available to the user for implementation as in Results step 360. This implementation can either be manual (implemented by a human being) or automated (implemented by a computer). If one or more of the reasonableness checks fails, or after the solution has been made available for implementation, the real-time optimizer waits for a programmed time in Wait step 370, before beginning the next solution cycle again.

FIG. 3a shows an example of a reduced model being used to optimize an operation. Model coefficients and measurements from the operation stored in relational database 380 are used by the reduced model 270 to periodically calculate the current optimal operation. The reduced model then implements the optimal solution by sending targets to multivariable controller 321. The multivariable controller sends individual setpoints to the control system 331, which controls the operation 341 by sending signals to the individual actuators 351, such as valves and motors. Measurements from the operation are periodically stored in the relational database.

FIG. 4 shows a high level view of a set of related applications of a reduced model generally classified as “economic analysis” of an operation. In the sense used here, the phrase “economic analysis” refers to the exploration and understanding of the detailed behavior of the operation at and around its optimum. While it is possible, if awkward, to conduct similar analyses using first-principles models, the speed, flexibility and robustness of a reduced model enables these applications to be carried out in practical time frames. After the application sequence is triggered by a user, the first step is to collect the data necessary to conduct the analyses. Such data are typically stored in Relational Database 380, possible examples of which are Microsoft Access or Microsoft SQL Server or other database suppliers (e.g. Oracle). Such a structured database is well-suited as a means to collect and retain data from disparate and distant sources, making these readily available to the applications described in this section. The database can also be used to persist results calculated by the reduced model and its applications.

In User Input step 420 the user selects which type of analysis to be carried out via a graphical interface. The heart of the analyses to be performed is a reduced model which resides in Relational Database 380 in the form of numerical model coefficients. The reduced model accurately simulates the nonlinear and economic behavior of the operation. Three exemplary applications are described in more detail below. The first of these is “Effects of bounds and costs” 430. The second is “Presentation of Optimal Operation” 440. The third is “Generate Operating Instructions” 450.

When a user elects to analyze “Effects of bounds and costs” 430, it is with the intent to understand more deeply the effects of different operating variables, costs and constraints on the optimal operation. Typically in undertaking such an analysis, a user will supply values for a set of current costs for all variables in the problem being studied. Using the example of a Catalytic Cracker, such costs could be feed cost, product prices, the price of electricity, the price of steam and so on. A user will then supply a consistent and current set of constraints for the variables. Using the Catalytic Cracker example, constraints would include the minimum and maximum allowable values for feed rate, feed temperature, reactor temperature, flue gas composition, product flow rates, product compositions, etc. Some variables may have both upper and lower constraints, while other variables may have only a single upper or lower constraint, while still others may not be constrained at all. Having supplied values for the costs and constraints, the reduced model and its associated optimization algorithm are invoked to calculate the effects of these costs and constraints on the “shape of the optimum”. The term “shape of the optimum” refers to a method of graphically displaying to a user a set of x-y plots of the objective function versus each independent or dependent variable. This type of analysis quickly shows which direction to move a single variable in order to more closely approach the optimal operation.

FIG. 4a details “Effects of bounds and costs” 430. The method used to generate these results begins with the calculation of the optimal operation which is defined by combination of the reduced model, the costs, the variable constraints and the specified objective function. Next, all but one candidate independent variable are held fixed at their optimal values, while the candidate independent variable is set to a number of different test values over a range of operation, and the objective function calculated at each of these values. After this the candidate independent variable is again fixed to its base value, and the next independent variable becomes a candidate and is similarly set to a number of new values, with the objective function evaluated at each of these. This procedure continues until all independent variables become candidates and are similarly perturbed. All of the results for all variables along with the accompanying objective function values are recorded and stored in the database for later presentation and analyses.

The image in FIG. 4a illustrates the user interface as implemented in Microsoft Visual Basic after the user has selected the option to analyze the “Effects of bounds and costs” 430, thereby invoking the calculations necessary to produce the graphical results shown. There are three exemplary plots 431, 432 and 433, each showing the impact of a single independent variable on the objective function. Plot 431 shows that as feed rate (x axis) increases, it causes the objective function (y axis) to increase. The lower bound for feedrate is denoted by vertical bar 434 while the upper bound for feed rate is denoted as 434′. Plot 432 shows the impact of another independent variable, reactor temperature (x axis), on the objective function (y axis). The current operating point is denoted by triangle 436 and the optimal operating point is denoted by diamond 435. In plot 432, the objective function increases as reactor temperature increases up to a point, then it levels off and starts to decrease as reactor temperature is increased farther.

Plot 433 shows the effect of preheat (x axis) on objective function (y axis). Note that the current operating point 436′ falls off the curve, indicating that the current operation is sub-optimal.

FIG. 4b details “Presentation of Optimal Operation” 440. When a user selects this option, it is with the intent to more deeply understand the detailed interrelationships between independent and dependent variables relative to the optimal operation. In order to generate the results, the user first specifies a consistent set of variable costs and constraints, then invokes the reduced model and its accompanying optimization algorithms to generate the four exemplary charts shown. The method used to generate the results begins with the calculation of the optimal operation which is defined by combination of the reduced model, the variable costs, the variable constraints and the specified objective function. Next a series of individual optimizations is conducted using a specialized method consisting of a series of steps. The first step is to fix independent variable 1 at its lower limit. The optimum is next calculated with variable 1 fixed at it lower limit. Variable 1 is subsequently fixed at a number of other values, each closer to variable 1's upper constraint limit, and the optimum is calculated for each fixed value of variable 1. This continues until variable 1 is fixed at its upper limit for a final calculation of the optimum. During the step of fixing variable 1 at a set of discrete values, all other independent and dependent variables are allowed to vary, but are constrained to remain within their specified upper and lower constraint limits. After variable 1 has been so perturbed over its range of operation, the series of optimal solutions is recorded in the database for later display and analyses. The next step in this analysis is to conduct a similar set of optimization runs with independent variable 2 being fixed at a number of values, spanning its lower and upper constraint limits. As before, all other independent and dependent variables are allowed to vary between their upper and lower constraint limits, and the optimal operation is computed for each fixed value of variable 2. During the subsequent steps of this method the same sequence is applied as each other independent variable is fixed at a series of values. At the end of this series of steps, the database will have been populated with the entire set of optimal results from all of the steps described above. These results are made available for analyses and inspection.

The plots in FIG. 4b illustrate the interface as implemented in Microsoft Visual Basic after the user has selected the option to analyze the “Presentation of optimal operation” and invoked the calculations necessary to produce the graphical results shown. The four plots 441, 442, 443 and 444 are grouped into two rows and two columns, and are based on a Catalytic Cracking example. Each row represents one dependent variable: the first row is for regenerator oxygen; the second row is for inlet oxygen concentration. Each column represents one independent variable: the first column is for feed rate; the second column is for riser temperature.

Plot 441 shows that the optimal value of regenerator oxygen is nearly constant at zero for all values of feedrate.

Plot 442 shows that the optimal value of regenerator oxygen is nearly constant at zero for all values of riser temperature.

Plot 443 shows that the optimal value of inlet oxygen initially decreases with feed rate, then increases at higher feed rates. The current (sub-optimal) operating point is designated by triangular marker 445. The current optimal operating point is designated by diamond marker 446. The lower bound for inlet oxygen is shown by horizontal hash mark 447, while the upper bound for inlet oxygen is shown by hash mark 447′.

Plot 444 shows that the optimal value of inlet oxygen initially is constant with riser temperature, then decreases at higher feed rates. The lower bound for riser temperature is shown by horizontal hash mark 448, while the upper bound for riser temperature is shown by hash mark 448′.

In a related analysis, a similar set of plots can be generated showing the optimal values of all independent variables relative to all of the other independent variables. Additionally a similar set of plots can be generated showing the optimal values of all dependent variables relative to all of the other dependent variables. Taken together, these graphical representations provide a user with a very efficient visual means to judge how best to operate, given any specific combination of values for independent and dependent variables.

FIG. 4c is illustrative of the result when a user selects the option to generate the “Generate operating instructions” 450. These operating instructions embody a verbal or text-based description of how best to run an operation. To obtain these operating instructions, the user specifies a consistent set of variable costs and constraints and then invokes the reduced model and its accompanying optimization algorithms to generate the optimal results—these are then stored in a relational database. One of the algorithms involved of this method translates the numerical optimization results into grammatically accurate language, English text in 450, which can be readily understood by a human being.

The image in FIG. 4c illustrates the interface as implemented in Microsoft Visual Basic after the user has selected the option to analyze the “Generate operating instructions” and invoked the calculations necessary to produce the results shown. FIG. 4c illustrates a number of lines of text on a display medium such as a computer CRT, the text including nouns and verbs, as well as the numerical representation of the optimal operation. Taken together, these lines of text describe in detail how to best run the operation. Using the example of a Catalytic Cracker, the line containing the text “Keep 5TC002 Preheat at maximum of 800 DegF” indicates that the optimum operation is to keep preheat temperature at its maximum of 800 degrees F. Although the example here is uncomplicated, merely describing which independent and which dependent variables to move in which direction, or against which constraint, such a verbal description of the optimal operation can be made significantly richer. For example, the results can be presented verbally by means of a speech synthesizer, or transmitted via a radio signal to a distant user. The results can also be made to contain additional details, for example regarding the consequences of moving constraints or of changing costs and prices, and can even suggest a set of prioritized alternate solutions, based on different realistic configurations of the operation being optimized. Using the Catalytic Cracking example, such a rich presentation could be as follows: “The optimal operation is to keep preheat at the maximum of 800 degrees F, while increasing O2 injection from the current value of 320 MSCFH (thousand standard cubic feet per hour) until the wet gas compressor current reaches a maximum value of 500 amps. At this point, it is likely that the propane flow will also be close to its maximum of 1,750 barrels per day. You should expect the fuel gas vent valve to be wide open or nearly so, and the fractionator bottoms temperature should be close to its maximum of 800 degrees F. The benefits of running the Catalytic Cracker at this operation compared to the current base operation are approximately $5,000 per day. In order to increase the profits further, the most profitable steps are to bypass the fuel gas vent valve, followed by cleaning the fractionator bottom pumparound heat exchanger.” This illustrative example is meant to show how numerical results from the optimization algorithms can be converted to easily-understood instructions and transmitted as plain language to a skilled user.

FIG. 5, details method 160 to calculate and make available for analyses and display a direct measure of the benefits of optimizing an operation. The sequence begins with Retrieval and Screening step 510, where the data required to execute the reduced model are retrieved from Relational Database 380. These data consist of reduced model coefficients, reduced model equations, values for all of the reduced model independent and dependent variables, model parameters, variable limits, as well as whatever economic costs are associated with the optimization objectives. For a Catalytic Cracker the independent variables will include such measurements as feed rate, feed composition, reactor temperature and reactor pressure. Dependent variables will include such measurements as product flowrates, product compositions and energy used. Economic costs will include such measurements as feed cost and product costs. The phrase “real-time” indicates that the model measurements are changing fast enough and significantly enough that the optimum of the operation is continually moving. Unless some deliberate and frequent action is taken to change the way the operation is running, it will be continually running in a sub-optimal way. For example, for a Catalytic Cracker, constantly varying feed compositions, or weather, or product values may require that the reactor temperature is constantly adjusted in order to keep the operation as close as possible to the rapidly moving optimum.

Operational data usually contain measurement noise and bad values. These bad values have many sources including; limited repeatability and reproducibility of automated and manual measurements, failure of instrumentation and unmeasured disturbances in the operation. Part of Retrieval and Screening step 510 is to remove such bad and noisy measurements from the raw data. Data screening involves a combination of statistical techniques (e.g. PLS) and heuristics (e.g. checking raw data against reasonability limits). Data which fail such reasonableness checks are filtered for noise removal, discarded and replaced with estimates, or replaced with surrogate measurements.

Screened data are used as the basis for Parameter Fit step 520. The most general algorithmic presentation of this fit step is given by Equation 4, or its alternate Equation 5 (both described above).

The reduced model, now possessing a set of parameters reflecting current operation, is used to calculate the nonlinear optimum of the operation, as shown in Optimize step 530. This calculation is detailed above in the section relating to Equation 6.

In Linear Optimization step 540, the optimal point of the operation is calculated, based on a linear model of the operation.

Nonlinear Optimization step 530 and Linear Optimization step 540 are used together to calculate a pair of “optimal” operations. These two “optimal” operations differ in the following way: one is the optimum based on a nonlinear model of the operation; the other is the optimum based on a linear model of the same operation. These two “optima” will generally be different, with the nonlinear optimum being a more accurate representation, and having a higher objective function value than the linear one. In essence, this method directly quantifies the value of the nonlinear optimization over the more commonly-available linear optimization. Referring again to the example of the Catalytic Cracker, most such processes in the world already have available a set of multivariable process controls which simultaneously keep the Catalytic Cracker running within safe operating limits (constraints) and push (optimize) the operation based on a linear model of the process. Due to the presence of these multivariable controls, it can be said that most Catalytic Crackers are already being optimized by use of linear optimizers. It is currently rarely the case, however, that Catalytic Crackers are optimized by use of nonlinear optimizers. When such a nonlinear optimizer is eventually installed on a Catalytic Cracker, most operators would want to know how much the incremental benefits (increase in objective function) are from such installation. It is the intention therefore, of the current invention described herein to address this issue of benefits measurement of a nonlinear optimizer as applied to an operation. This method is clearly extensible to other situations which have available an existing linear optimizer and are planning to add, or have already added a nonlinear optimizer in addition.

In Linear Optimization step 540 the second or linear “optimum” of the operation is calculated. This calculation is performed using the same Equation 6 described above, with the exception that the constraints equations are now linear. It is important to note that the objective function is identical to the one used in Nonlinear Optimization step 530 described above, as are the variable set, cost and price values for the variables, and the values for the upper and lower limits of all variable constraints. In fact the linear model structure is identical to the nonlinear model structure with the exception that the coefficients used to define the model now contain no nonlinear terms.

The linear model coefficients are derived in practice one of two ways. The first is to mathematically differentiate a nonlinear model around the current operating point by perturbing individual independent variables slightly, solving the nonlinear model, and quantifying the change in all dependent variables relative to the change in each independent variable. Each change in dependent variable relative to each change in an independent variable becomes a coefficient in the linear model. Such an approach to obtaining linear approximations is often referred to a “Finite Difference” and is well described in the literature, including the references already listed, Fletcher (1987) and Gill, et al. (1981). Such set of linear model coefficients is described in these references and others as a “Jacobian matrix”. The second common method of producing a linear model is to perturb individual independent variables in the actual operation being studied, and measure the resulting changes in the dependent variables directly in the operation. This method known as “step testing” or “plant testing” is well documented in the literature—an excellent reference is Blevins, McMillan, Wojsznis and Brown (2003).

Elaborating on Linear optimum step 540, the linear model is driven to its “optimum” solution by an algorithm similar (or identical) to the one used to calculate the nonlinear optimum. The same nonlinear objective function used to calculate the nonlinear optimum (Nonlinear Optimization step 530) is then evaluated using the linear optimal solution just calculated as in Linear Optimization step 540. This linear optimization procedure produces an objective function value that can be directly compared to the nonlinear objective function value already available. Using the illustrative Catalytic Cracking example, the two calculations might produce the following results:

TABLE 2
Example Nonlinear Optimum solution versus Linear
Optimum solution for a Catalytic Cracker

| | Nonlinear | Linear |
|---|---|---|
| | Optimum | Optimum |
| Feed rate (BPD) | 19,028 | 19,026 |
| Reactor temperature (Degrees F.) | 996.8 | 1,012 |
| Profit ($/day) | 8,654 | 7,492 |

This result shows that the benefit due to nonlinear optimization is $8,654 per day - $7,492 per day or $1,162 per day. The comparison of linear and nonlinear optima is illustrated by Comparison step 550. After this comparison is done, the comparison, plus all prior results are stored in data Relational Database 380. The calculation waits as per Wait step 560 for the next execution cycle to begin.

FIG. 5a illustrates Comparison step 5 in detail. At the request of a user, the database containing the benefits calculation results is queried and presents the results in the form of the two plots provided here. Plot 551 is shown to contain two lines; an upper line 554 a lower line 553. Line 554 shows the nonlinear objective function value over time. Line 553 shows the linear objective function value over time. Each point on each line 554 and 553 represents a single execution of the calculation as described in FIG. 5. At any given time (x axis value) the difference (on the y axis) between Line 553 and Line 554 represents the instantaneous benefit of nonlinear optimization.

For example, a Catalytic Cracker may have the following results:

TABLE 2
Example Nonlinear Optimum versus Linear Optimum
over time for a Catalytic Cracker

| | Nonlinear | Linear |
|---|---|---|
| | Optimum | Optimum |
| | (Line 554) | (Line 553) |
| Time 1 | 8,654 | 7,492 |
| Time 2 | 8,712 | 7,671 |
| Time 3 | 8,906 | 7,005 |

Given these results, the instantaneous nonlinear optimization benefits would be:

TABLE 3
Example of instantaneous optimization benefits
over time

| | Nonlinear |
|---|---|
| | Optimization |
| | Benefit |
| | (Line 554 − Line 553) |
| Time 1 | 1,162 |
| Time 2 | 1,041 |
| Time 3 | 1,901 |

The difference between Line 553 and Line 554 can be integrated over time calculate the total optimization benefits over time. This latter integration calculation is shown in Plot 552 as line 555.

Using the Catalytic Cracker example above, the nonlinear optimization benefits integrated over the first three time intervals would be:

TABLE 4
Example of optimization benefits integrated over
time

| | Integrated |
|---|---|
| | Nonlinear |
| | Optimization |
| | Benefit |
| | (Line 555) |
| Time 1 | 1,162 |
| Time 2 | 2,203 |
| Time 3 | 4,104 |

The particular implementations described, and the discussions regarding details, and the specifics of the figures included herein, are purely exemplary; these implementations and the examples of them, may be modified, rearranged and/or enhanced without departing from the principles of the present invention.

The particular features of the user interface and the performance of the application, will depend on the architecture used to implement a system of the present invention, the operating system of the computers selected, the communications channel selected, and the software code written. It is not necessary to describe the details of such programming to permit a person of ordinary skill in the art to implement an application and user interface suitable for incorporation in a computer system within the scope of the present invention. The details of the software design and programming necessary to implement the principles of the present invention are readily understood from the description herein. However, in the interest of redundancy, exemplary code for a preferred implementation is given in APPENDIX A.

Various additional modifications of the described embodiments of the invention specifically illustrated and described herein will be apparent to those skilled in the art, particularly in light of the teachings of this invention. It is intended that the invention cover all modifications and embodiments which fall within the spirit and scope of the invention. Thus, while preferred embodiments of the present invention have been disclosed, it will be appreciated that it is not limited thereto but may be otherwise embodied within the scope of the following claims.

I claim as my invention:

1. A method for constructing a reduced nonlinear model of a first operation comprising the steps of:
a) providing said first operation, said first operation having
at least one condition having a condition value affecting said first operation,
at least one control having a setting value for adjusting said first operation, and
at least one product having a measurable value;
b) providing a calibrated first-principles model of said first operation,
the first-principles model having
a first set of independent variables comprising
a condition variable corresponding to the condition value of each of said at least one condition and
a control variable corresponding to the setting value of each of said at least one control,
the first-principles model further having
a first set of dependent variables comprising
a product variable corresponding to the measurable value of each of said at least one product;
c) defining a scope for said reduced nonlinear model,
said scope representing a second operation,
said second operation consisting of at least a portion of said first operation,
said at least a portion of said first operation to be represented by said reduced nonlinear model,
said second operation being of interest and said scope comprising
a second set of independent variables consisting of at least a portion of said first set of independent variables,
wherein at least one of said set of independent variables corresponds to one of said at least one control, and
said scope further comprising
a second set of dependent variables consisting of at least a portion of said first set of dependent variables,
d) selecting a Design of Experiments set comprising
a first member having
a first value corresponding to each of said first set of independent variables, and
at least one second member having
a second value corresponding to at least one of said first set of independent variables,
said second value being different from the corresponding first value,
the second member further having
each of the remaining ones of said first set of independent variables being held at the corresponding first value;
e) exercising said first-principles model
with each member of said Design of Experiments set
to produce a corresponding first-principles result;
f) selecting for said reduced nonlinear model,
for each of said second set of dependent variables a corresponding function comprising
at least one of said second set of independent variables,
said corresponding function further comprising
at least one model coefficient;
and wherein at least one of said corresponding function is nonlinear;
g) calculating for each of said at least one model coefficient a fitted value
such that a result of the function best matches the corresponding first-principles result over said Design of Experiments set;
h) exercising said reduced nonlinear model
with a third value for each of said second set of independent variables
to produce an estimate for each said measurable value of said at least one product of said first operation within said scope
whereby said estimate is achieved
at a substantially reduced computational burden and
with reduced computational fragility.

2. The method of claim 1, wherein said scope further comprises
at least one constraint corresponding to a constrained variable selected from the set consisting of
said second set of dependent variables and
said second set of independent variables.

3. The method of claim 1, wherein
said first value and said second value comprise extreme values which
at least span an expected operating range for the corresponding one of said first set of independent variables, and
said third value lies within said expected operating range,
whereby the reduced nonlinear model applies to an expected operating range of the second operation.

4. The method of claim 1, wherein
said Design of Experiments set further comprises
at least one third member having
a fourth value corresponding to each of a plurality of said first set of independent variables,
said fourth value being different from the corresponding first value,
the third member further having
each of the remaining ones of said first set of independent variables being held at the corresponding first value.

5. The method of claim 1,
wherein said reduced nonlinear model has an error with respect to said calibrated first-principles model,
further comprising the steps of:
i) measuring said error by comparing over said Design of Experiments set each of said first-principles result to the corresponding result of the function;
j) selecting for said reduced nonlinear model,
for at least one of said second set of dependent variables a replacement function comprising
at least one of said second set of independent variables,
said replacement function further comprising
at least one model coefficient;
said replacement function supplanting the function previously selected to correspond to said at least one of said second set of dependent variables; and,
k) repeating steps g), i) and j) while said error exceeds a predetermined error value,
whereby said reduced nonlinear model is accurate substantially to within said predetermined error value.

6. The method of claim 5, wherein said replacement function is of a higher order than the function previously selected.

7. The method of claim 5, wherein said replacement function is of a lower order than the function previously selected.

8. A reduced nonlinear model representing a portion of interest of a first operation,
said first operation having
at least one condition having a condition value affecting said first operation,
at least one control having a setting value for adjusting said first operation, and
at least one product having a measurable value,
said first operation further being modeled by a calibrated first-principles model,
said calibrated first-principles model having
a first set of independent variables comprising
a condition variable corresponding to the condition value of each of said at least one condition and
a control variable corresponding to the setting value of each of said at least one control,
said calibrated first-principles model further having
a first set of dependent variables comprising
a product variable corresponding to the measurable value of each of said at least one product,
said calibrated first-principles model capable of being fully specified by
said condition value corresponding to said first set of independent variables and
said setting value corresponding to said first set of independent variables
to produce a first prediction of said measurable value,
said reduced nonlinear model comprising
a scope representing a second operation,
said second operation consisting of said portion of interest of said first operation,
said scope comprising
a second set of independent variables consisting of
at least a portion of said first set of independent variables,
said scope further comprising
a second set of dependent variables consisting of
at least a portion of said first set of dependent variables,
said reduced nonlinear model further comprising
a function corresponding to each of said second set of dependent variables,
said function having at least one parameter,
each parameter of said function consisting of one of said second set of independent variables,
said function having at least one coefficient,
said function representing the behavior of the corresponding measurable value, and
at least one of said function being nonlinear,
said reduced nonlinear model capable of being fully specified by
said condition value corresponding to said second set of independent variables and
said setting value corresponding to said second set of independent variables
to produce a second prediction of said measurable value,
said second prediction substantially matching said first prediction over said second set of dependent variables,
whereby said reduced nonlinear model can provide said second prediction with lower computational burden and increased reliability.

9. The reduced nonlinear model of claim 8, wherein said scope further comprises
at least one constraint corresponding to a constrained variable selected from the set consisting of
said second set of dependent variables and
said second set of independent variables.

10. A method for real-time optimization of said second operation using said reduced nonlinear model of claim 8, wherein
said scope further comprises at least one constraint corresponding to a constrained variable selected from the set consisting of
said second set of dependent variables and
said second set of independent variables,
said scope further comprises an objective function,
said objective function having at least one first parameter selected from said second set of independent variables,
said objective function further having at least one second parameter selected from said second set of dependent variables,
comprising the steps of:
a) providing operating data for said scope,
said operating data comprising
said measurable value corresponding to each dependent variable corresponding to said scope, and
an input value for each said parameter of each said function,
said input values consisting of a corresponding member of the group consisting of said condition value and said setting value,
b) determining at least one target setting value for said second operation,
said target setting value producing a substantially best result of said objective function when
said objective function is evaluated from the reduced nonlinear model from said operating data when a corresponding setting value is substituted with said target setting value;
c) prescribing said target setting value for the corresponding control; and,
d) repeatedly performing steps a), b) and c);
whereby said second operation is continually optimized with respect to said objective function.

11. The method of claim 10, further comprising the step of
e) screening said operating data according to first predetermined rules,
said first predetermined rules identifying screened operating data, comprising any of said input values and said measurable values in said operating data having a quality selected from the group consisting of bad and noisy,
said first predetermined rules further performing upon said screened operating data an action selected from the group of discard, correct, limit, and filter operating data so identified,
wherein step d) further comprises repeated performance of step e),
whereby said optimization process is substantially immune to bad and noisy operating data.

12. The method of claim 10, wherein
a third operation to be the subject to real-time optimization consists of at least a portion of said second operation and wherein at least one said function corresponding to said third operation further comprises an intercept parameter,
further comprising the steps of:
f) providing operating data for said third operation,
said operating data comprising
said measurable value corresponding to each dependent variable corresponding to said third operation,
an input value for each parameter of each function corresponding to each dependent variable corresponding to said third operation,
the input values being corresponding members of the group consisting of said condition value and said setting value; and,
g) fitting said reduced nonlinear model to said operating data by
setting said intercept parameter to said measurable value minus
the corresponding function evaluated with the corresponding said input value; and,
h) repeatedly performing steps f) and g);
whereby said reduced nonlinear model is fitted in real-time to the actual behavior of said second operation.

13. The method of claim 10, wherein
a third operation to be the subject to real-time optimization consists of at least a portion of said second operation and wherein at least one said function corresponding to said third operation further comprises an intercept parameter and a slope parameter,
further comprising the steps of:
i) providing operating data for said third operation,
said operating data comprising
said measurable value corresponding to each dependent variable corresponding to said third operation,
an input value for each parameter of each function corresponding to each dependent variable corresponding to said third operation,
the input values being corresponding members of the group consisting of said condition value and said setting value; and,
j) fitting said reduced nonlinear model to said operating data by setting said slope parameter and said intercept parameter to
minimize the magnitude of said measurable value in said operating data minus
the corresponding function evaluated with the corresponding said input value
plus the difference between said intercept parameter and the initial value of said intercept parameter; and,
k) repeatedly performing steps i) and j);
whereby said reduced nonlinear model is fitted in real-time to the actual behavior of said second operation.

14. A method for displaying the relationships between the variables calculated by said reduced nonlinear model of claim 8, comprising the steps of:
a) providing a computer, said computer having software, said software comprising an implementation of said reduced nonlinear model;
b) providing at least one constraint corresponding to a constrained variable selected from the set consisting of
said second set of independent variables and
said second set of dependent variables;
c) providing an objective function,
said objective function having at least one first parameter selected from said second set of independent variables,
said objective function further having at least one second parameter selected from said second set of dependent variables;
d) calculating the optimal operation, said optimal operation being defined by
the set of optimal independent variable values for each of said second set of independent variables,
the set of optimal dependent variable values wherein each of said second set of dependent variable values is defined by said function corresponding to each of said second set of dependent variables,
said set of optimal independent variable values selected so that said objective function value is substantially improved,
said set of optimal independent variable values being within said constraints,
said set of optimal dependent variable values being within said constraints;
e) evaluating the effects on said objective function of varying each of said second set of independent variables, said evaluation being defined by;
f) providing a test independent set, wherein each member of said test independent set corresponds to a member of said second set of independent variables;
g) providing a test objective function set wherein the first member of said test objective function set is equal to said optimal operation,
h) providing a test dependent set, wherein each member of said dependent test set corresponds to a member of said second set of dependent variables;
i) assigning a base value to each member of said test independent set wherein said base value is equal to the corresponding member of said set of optimal independent variable values,
j) assigning at least one test value for a member of said test independent set, said test value having a value different from said base value,
k) calculating a member of said test objective function set wherein said member of said test objective function set is equal to said optimal operation evaluated at the values provided by said test independent set,
l) calculating the members of said test dependent set wherein each of said members of said test dependent set is equal to the corresponding member of said set of optimal dependent variables evaluated at the values provided by said test independent set,
k) repeating steps i, j, k and l until each member of said test independent set has been assigned a test value;
m) plotting said test objective function set versus said test independent set, wherein said plotting comprises,
n) preparing an x-y chart using a visual plotting device, said x-y chart comprising,
on the x axis, a member of said test independent set,
on the y axis, the member of said test objective function set corresponding to said member of said test independent set;
p) repeating step n until all members of said test independent set have been plotted;
whereby said relationships between variables are readily displayed, efficiently and with reduced burden on the user.

15. A method for displaying the relationships between the variables calculated by said reduced nonlinear model of claim 8, comprising the steps of:
a) providing a computer, said computer having software, said software comprising an implementation of said reduced nonlinear model;
b) providing at least one constraint corresponding to a constrained variable selected from the set consisting of
said second set of independent variables and
said second set of dependent variables, wherein
said at least one constraint comprises a lower constraint value and a higher constraint value;
c) providing an objective function,
said objective function having at least one first parameter selected from said second set of independent variables,
said objective function further having at least one second parameter selected from said second set of dependent variables;
d) calculating the optimal operation, said optimal operation being defined by
the set of optimal independent variable values for each of said second set of independent variables,
the set of optimal dependent variable values wherein each of said second set of dependent variable values is defined by said function corresponding to each of
said second set of dependent variables, said set of optimal independent variable values selected so that said objective function value is substantially improved,
said set of optimal independent variable values being within said constraints,
said set of optimal dependent variable values being within said constraints;
e) evaluating the effects on said optimal operation by varying each of said second set of independent variables, said evaluation being defined by;
f) providing a specification independent set, wherein each member of said specification independent set corresponds to a member of said second set of independent variables, wherein each member of said specification independent set further comprises,
a low base value,
said low base value being greater than or equal to said lower constraint value for said corresponding member of said specification independent variable set,
a high base value,
said high base value being less than or equal to said upper constraint value for said corresponding member of said specification independent variable set,
at least one intermediate base value,
said at least one intermediate base value being greater than said low base value and less than said high base value;
g) providing a results independent set, wherein each member of said results independent set corresponds to a member of said second set of independent variables;
h) providing a results dependent set, wherein each member of said results dependent set corresponds to a member of said second set of dependent variables;
i) calculating a sequence of optimal results wherein each member of said sequence of optimal results comprises;
j) selecting one member of said specification independent set;
k) calculating said optimal operation, wherein each member of said results independent set is allowed to vary, according to said optimal calculation;
l) recording said each member of said results dependent set at said optimal operation;
m) plotting said sequence of optimal results, wherein said plotting comprises;
n) preparing an x-y chart for each of said member of said results independent set comprising,
on the y axis said member of said results independent set,
on the x axis the corresponding member of said of said specification independent set;
o) repeating step n until each of said member of said results independent set has been plotted;
p) repeating step o until each of said member of said specification independent set has been plotted;
q) preparing an x-y chart for each of said member of said results independent set comprising,
on the y axis said member of said results dependent set,
on the x axis the corresponding member of said of said specification independent set;
r) repeating step q until each of said member of said results dependent set has been plotted;
s) repeating step r until each of said member of said specification independent set has been plotted;
whereby said relationships between variables are readily displayed, efficiently and with reduced burden on the user.

16. A display showing relationships between variables calculated by a reduced nonlinear model of claim 8 comprising:
a computer, said computer having first software, said first software comprising an implementation of said reduced nonlinear model,
at least one constraint corresponding to a constrained variable selected from the set consisting of
said second set of independent variables and
said second set of dependent variables, an objective function,
said objective function having at least one first parameter selected from said second set of independent variables,
said objective function further having at least one second parameter selected from said second set of dependent variables,
a calculation of the optimal operation, said optimal operation being defined by
the set of optimal independent variable values for each of said second set of independent variables,
the set of optimal dependent variable values wherein each of said second set of dependent variable values is defined by said function corresponding to each of said second set of dependent variables,
said set of optimal independent variable values selected so that said objective function value is substantially improved,
said set of optimal independent variable values being within said constraints,
said set of optimal dependent variable values being within said constraints,
the optimal objective function value equal to said objective function value of said optimal operation,
an independent variable base point comprising base values for each of said independent variables,
an independent variable range set, each member of said independent variable range set corresponding to one of said second set of independent variables and further comprising
a low base value,
said low base value being greater than or equal to the lower constraint value for said one of said second set of independent variables,
a high base value,
said high base value being less than or equal to the upper constraint value for said one of said second set of independent variables,
at least one intermediate base value,
said at least one intermediate base value being greater than said low base value and less than said high base value,
an objective function range set, each member of said objective function range set comprising
objective function values evaluated
for each member of said independent variable range set wherein,
said independent variable values not contained in said independent variable range set remains fixed at said independent variable base point,
a set of x-y charts, each of said x-y charts comprising
said objective function range set plotted on the y axis of said x-y chart,
said independent variable range set plotted on the x-axis of said x-y chart.
whereby said display provides information regarding the behavior around said optimal operation, not readily apparent by other means.

17. A display showing relationships between variables calculated by the reduced nonlinear model of claim 8 comprising:
a computer, said computer having first software, said first software comprising an implementation of said reduced nonlinear model,
at least one constraint corresponding to a constrained variable selected from the set consisting of
said second set of independent variables and
said second set of dependent variables,
an objective function,
said objective function having at least one first parameter selected from said second set of independent variables,
said objective function further having at least one second parameter selected from said second set of dependent variables,
a calculation of the optimal operation, said optimal operation being defined by
the set of optimal independent variable values for each of said second set of independent variables,
the set of optimal dependent variable values wherein each of said second set of dependent variable values is defined by said function corresponding to each of said second set of dependent variables,
said set of optimal independent variable values selected so that said objective function value is substantially improved,
said set of optimal independent variable values being within said constraints,
said set of optimal dependent variable values being within said constraints,
the optimal objective function value equal to said objective function value of said optimal operation,
an independent variable range set,
each member of said independent variable range set corresponding to one of said second set of independent variables and further comprising
values of said each member of said independent variable range set, said values comprising
a low base value,
said low base value being greater than or equal to the lower constraint value for said each member of said independent variable,
a high base value,
said high base value being less than or equal to the upper constraint value for said each member of said independent variable,
at least one intermediate base value,
said intermediate base value being greater than said low base value and less than said high base value,
a results range set comprising members,
for each member of said independent variable range set
the optimal dependent values for each of said second set of dependent variables,
the optimal independent values for each of said second set of independent variables not being equal to said member of said independent variable range set,
a first set of x-y charts
each member of said first set of x-y charts comprising
said optimal dependent values plotted on the y axis of said first set of x-y charts,
said optimal independent values plotted on the x-axis of said first set of x-y charts,
a second set of x-y charts
each member of said second set of x-y charts comprising
said optimal independent values plotted on the y axis of said second set of x-y charts,
said optimal independent values plotted on the x-axis of said second set of x-y charts.
whereby said display provides information regarding the behavior around said optimal operation, not readily apparent by other means.

18. A method for displaying the optimum for an operation, calculated by said reduced nonlinear model of claim 8, comprising the steps of:
a) providing a computer, said computer having software, said software comprising an implementation of said reduced nonlinear model;
b) providing at least one constraint corresponding to a constrained variable selected from the set consisting of
said second set of independent variables and
said second set of dependent variables;
c) providing an objective function,
said objective function having at least one first parameter selected from said second set of independent variables,
said objective function further having at least one second parameter selected from said second set of dependent variables;
d) calculating the optimal operation, said optimal operation being defined by
the set of optimal independent variable values for each of said second set of independent variables,
the set of optimal dependent variable values wherein each of said second set of dependent variable values is defined by said function corresponding to each of said second set of dependent variables,
said set of optimal independent variable values selected so that said objective function value is substantially improved,
said set of optimal independent variable values being within said constraints,
said set of optimal dependent variable values being within said constraints;
e) converting said optimal operation into human language
said human language consisting of written text
said written text comprising
grammatically complete sentences describing said optimal operation,
said written text further comprising
grammatically approximate sentences describing said optimal operation;
f) displaying said human language on a display medium said display medium being readable by a person.
whereby displaying said human language version of said optimal operation allows a rapid and straightforward interpretation of said optimal operation.

19. A display showing the optimal operation calculated by said reduced nonlinear model of claim 8 comprising:
a computer, said computer having first software, said first software comprising an implementation of said reduced nonlinear model,
at least one constraint corresponding to a constrained variable selected from the set consisting of
said second set of independent variables and
said second set of dependent variables,
an objective function,
said objective function having at least one first parameter selected from said second set of independent variables,
said objective function further having at least one second parameter selected from said second set of dependent variables,
a calculation of the optimal operation, said optimal operation being defined by
the set of optimal independent variable values for each of said second set of independent variables,
the set of optimal dependent variable values wherein each of said second set of dependent variable values is defined by said function corresponding to each of said second set of dependent variables,
said set of optimal independent variable values selected so that said objective function value is substantially improved,
said set of optimal independent variable values being within said constraints,
said set of optimal dependent variable values being within said constraints,
the optimal objective function value equal to said objective function value of said optimal operation,
a presentation of said optimal operation in human-readable form comprising
a description of said optimal operation
said description comprising at least
nouns,
verbs, and
said optimal operation,
a display comprising any medium capable of being viewed by a person,
whereby said display of said optimal operation allows a rapid and straightforward interpretation of said optimal operation.

20. The method of claim 18 wherein the optimal solution is transmitted to a remote location by means of a radio frequency signal.

21. The apparatus of claim 19 wherein the optimal solution is transmitted to a remote location by means of a radio frequency signal.

22. A method for calculating the optimization benefits for an operation calculated by said reduced nonlinear model of claim 8 comprising the steps of:
a) providing a computer, said computer having first software, said first software comprising an implementation of said reduced nonlinear model;
b) providing second software comprising a linear model, wherein said linear model is substantially similar to said reduced nonlinear model, wherein further said function corresponding to each of said second set of dependent variables in said linear model is a linear relationship;
c) providing at least one constraint corresponding to a constrained variable selected from the set consisting of
said second set of independent variables and
said second set of dependent variables;
d) providing an objective function,
said objective function having at least one first parameter selected from said second set of independent variables,
said objective function further having at least one second parameter selected from said second set of dependent variables;
e) calculating the optimal operation, said optimal operation being defined by
the set of optimal independent variable values for each of said second set of independent variables,
the set of optimal dependent variable values wherein each of said second set of dependent variable values is defined by said function corresponding to each of said second set of dependent variables,
said set of optimal independent variable values selected so that said objective function value is substantially improved,
said set of optimal independent variable values being within said constraints,
said set of optimal dependent variable values being within said constraints,
the optimal objective function value equal to said objective function value of said optimal operation;
f) calculating the linear optimal operation, said linear optimal operation being defined by
the set of linear optimal independent variable values for each of said second set of independent variables,
the set of linear optimal dependent variable values wherein each of said second set of dependent variable values is defined by said linear relationship corresponding to each of said second set of dependent variables,
said set of linear optimal independent variable values selected so that said objective function value is substantially improved,
said set of linear optimal independent variable values being within said constraints,
said set of linear optimal dependent variable values being within said constraints,
the linear objective function value equal to said objective function value of said linear optimal operation;
g) subtracting said linear objective function value from said optimal objective function value to produce an instantaneous optimization benefit,
h) integrating said instantaneous optimization benefit over time to produce an integrated optimization benefit, said integration calculated by adding said current instantaneous optimization benefit to the last available said integrated optimization benefit,
i) displaying said instantaneous optimization benefit on a display medium,
j) displaying said integrated optimization benefit on a display medium.
whereby displaying said optimization benefits allows a rapid and automated tracking and display of said benefits.

23. A display of the optimization benefits for an operation calculated by a reduced nonlinear model of claim 8 comprising:
a computer, said computer having first software, said first software comprising an implementation of said reduced nonlinear model,
second software comprising a linear model, wherein said linear model is substantially similar to said reduced nonlinear model, wherein further said function corresponding to each of said second set of dependent variables in said linear model is a linear relationship,
at least one constraint corresponding to a constrained variable selected from the set consisting of
said second set of independent variables and
said second set of dependent variables,
an objective function,
said objective function having at least one first parameter selected from said second set of independent variables,
said objective function further having at least one second parameter selected from said second set of dependent variables,
a calculation of the optimal operation, said optimal operation being defined by
the set of optimal independent variable values for each of said second set of independent variables,
the set of optimal dependent variable values wherein each of said second set of dependent variable values is defined by said function corresponding to each of said second set of dependent variables,
said set of optimal independent variable values selected so that said objective function value is substantially improved,
said set of optimal independent variable values being within said constraints,
said set of optimal dependent variable values being within said constraints,
the optimal objective function value equal to said objective function value of said optimal operation,
a calculation of the linear optimal operation, said linear optimal operation being defined by
the set of linear optimal independent variable values for each of said second set of independent variables,
the set of linear optimal dependent variable values wherein each of said second set of dependent variable values is defined by said linear relationship corresponding to each of said second set of dependent variables,
said set of linear optimal independent variable values selected so that said objective function value is substantially improved,
said set of linear optimal independent variable values being within said constraints,
said set of linear optimal dependent variable values being within said constraints,
the linear objective function value equal to said objective function value of said linear optimal operation,
a calculation of the instantaneous optimization benefit, said calculation of the instantaneous optimization benefit performed by subtracting said linear objective function value from said optimal objective function value,
a calculation of the integrated optimization benefit said calculation of the integrated optimization benefit performed by adding said current instantaneous optimization benefit to the last available said integrated optimization benefit,
a display showing said instantaneous optimization benefit,
a display showing said integrated optimization benefit
whereby said display of optimization benefits allows a rapid and automated tracking of said benefits.
